(19) United States
(12) Patent Application Publication
(10) Pub. No.: US 2006/0287064 A1
(43) Pub. Date: Dec. 21, 2006

(54) Gaming machine

(75) Inventor: Yukinori Inamura, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Aruze Corporation, Tokyo (JP)

(21) Appl. No.: 11/495,462

(22) Filed: Jul. 31, 2006

(30) Foreign Application Priority Data
Apr. 22, 2004 (JP) 2004-127164

(51) Int. Cl. A63F 13/00

(52) U.S. Cl. 463/20

(57) ABSTRACT

During the execution of the basic game, the basic game virtual reels are varied/stopped in the variable display sections respectively. On the other hand, during the execution of the bonus game, the bonus game virtual reel is varied/stopped in each of the stop display regions of the variable display sections.

### RELATED APPLICATIONS

This application relates to Japanese Patent Application No. 2004-127164 filed on Apr. 22, 2004, which is incorporated herein by reference.

### BACKGROUND OF THE INVENTION

1. Field of the Invention

The present invention relates to a gaming machine in which a video slot game is played.

2. Description of the Prior Art

A conventional gaming machine such as a slot machine is configured such that a plurality of reels are rotated for a predetermined period of time, and coins or the like are paid out in response to a combination of symbols obtained when each of the reels is stopped. Slot machines can be classified by the patterns of the reels: mechanical slot machines, which are provided with a plurality of rotatable reels having symbols on the external surfaces of rotating bodies thereof; and video slot machines, which rotate a plurality of virtual reels displayed by a display device (see, for example, Japanese Unexamined Patent Publication No. 2003-180908).

In this regard, there is no mechanical constraint on each reel in the video slot machines, thus, for example, a plurality of reels for a basic game which are used in a basic game only and a plurality of reels for a bonus game which are used only in a bonus game can be prepared separately, and these plurality of reels can be rotated for the basic games or bonus games respectively, so that changes can be brought about in video slot games.

However, during the bonus game, the plurality of reels for a bonus game are always rotated or stopped and the same payout characteristics are effected every time. As a result, even if some changes are brought about in the video slot games by separately preparing the reels for a basic game and the reels for a bonus game which are used in the video slot games, the video slot games sometimes become boring.

### SUMMARY OF THE INVENTION

The present invention is contrived in view of such circumstances, and an object thereof is to provide a gaming machine which can bring a wide variety of changes in the characteristics of a bonus game in a video slot game.

In order to achieve the above object, the invention according to claim 1 is a gaming machine (for example, a slot machine 1), comprising: a plurality of basic reel strips (for example, a first reel strip 101, a second reel strip 102, a third reel strip 103, a fourth reel strip 104, and a fifth reel strip 105) which are used in a basic game only and on which a plurality of symbols are disposed respectively; a plurality of variable display sections (for example, variable display sections 21 through 25) which perform variable/stop display of the symbols on the respective basic reel strips (for example, the first reel strip 101, second reel strip 102, third reel strip 103, fourth reel strip 104, and fifth reel strip 105); a plurality of stop display regions (for example, stop display regions 211 through 213, 221 through 223, 231 through 233, 241 through 243, and 251 through 253) which are respectively demarcated in the variable display sections (for example, the variable display sections 21 through 25) and on which one of the symbols on the basic reel strips (for example, the first reel strip 101, second reel strip 102, third reel strip 103, fourth reel strip 104, and fifth reel strip 105) is displayed in a stop state; game control means (for example, a CPU 50) for using the symbols displayed respectively on the variable display sections (for example, the variable display sections 21 through 25) in a variable/stop state, to execute a video slot game which is constituted from the basic game and a bonus game; and a special reel strip (for example, a bonus game reel strip 111) which is used only in the bonus game and is formed with symbols the number of which is less than the number of symbols on the basic reel strips (for example, the first reel strip 101, second reel strip 102, third reel strip 103, fourth reel strip 104, and fifth reel strip 105), wherein the game control means (for example, the CPU 50) executes the bonus game by displaying the symbols, which are formed on the special reel strip (for example, the bonus game reel strip 111), in the variable/stop state in the stop display regions (for example, the stop display regions 211 through 213, 221 through 223, 231 through 233, 241 through 243, and 251 through 253) respectively.

Further, in the gaming machine according to claim 2, the game control means performs control so as to make a shift to the bonus game when a predetermined symbol is displayed in a stop state by a predetermined number or more in the variable display section, regardless of active pay lines.

Moreover, in the gaming machine according to claim 3, the game control means performs lottery processing of the bonus game when determination is made that the bonus game is won, and determines a symbol to be displayed in a stop state on each of the stop display regions, for each of the stop display regions by means of sampling processing performed by a random number sampling circuit.

In addition, the gaming machine according to claim 4, the symbol formed on the special reel strip comprises one type of the symbols formed on the basic reel strips and a blank symbol.

Further, the gaming machine according to claim 5, the variable display section comprises a liquid crystal display, each of the stop display regions comprises a part of the liquid crystal display region of the variable display section, and each of the basic reel strips and each of the special reel strips comprise a virtual reel demarcated on the liquid crystal display.

Further, the invention according to claim 6 is a gaming machine, comprising: a plurality of reels; a plurality of basic reel strips which are utilized in a basic game only and are corresponding to the plurality of reels respectively, and on which a plurality of symbols are disposed respectively; a special reel strip which is utilized only in the bonus game and is corresponding to the plurality of reels respectively, and is formed with a plurality of symbols the number of which is less than the number of symbols on the basic reel strips; and a processor programmed to operate with the plurality of reels, the plurality of basic reel strips and one type special reel strip to enable a player to initiate the basic game by making a bet, to play the basic game by utilizing the plurality of basic reel strips on the plurality of reels, to make a shift to the bonus game when a predetermined condition is satisfied in the basic game, and to play the bonus game by utilizing the one type special reel strip on the plurality of reels.

Moreover, the invention according to claim 7 is a gaming machine, comprising: a plurality of reels; a plurality of basic reel strips which are utilized in a basic game only and are corresponding to the plurality of reels respectively, and on which a plurality of symbols are disposed respectively; a special reel strip which is utilized only in the bonus game and is corresponding to the plurality of reels respectively, and is formed with a plurality of symbols comprising at least one type of winning symbol and blank symbol; and a processor programmed to operate with the plurality of reels, the plurality of basic reel strips and one type special reel strip to enable a player to initiate the basic game by making a bet, to play the basic game by utilizing the plurality of basic reel strips on the plurality of reels, to make a shift to the bonus game when a predetermined condition is satisfied in the basic game, and to play the bonus game by utilizing the one type special reel strip on the plurality of reels.

### BRIEF DESCRIPTION OF THE DRAWINGS

FIG. 1 is an explanatory diagram showing virtual reels which are used in a bonus game;

FIG. 2 is a perspective view of a slot machine;

FIG. 3 is a front view of a control panel;

FIG. 4 is a block diagram schematically showing a control system of the slot machine;

FIG. 5 is a block diagram schematically showing a liquid crystal drive circuit of a lower liquid crystal display;

FIG. 6 is an explanatory diagram schematically showing symbol columns which are displayed variably by a variable display section in a basic game;

FIG. 7 is a figure showing one of the symbols constituting the symbol columns;

FIG. 8 is an explanatory diagram showing a winning combination and its award;

FIG. 9 is an explanatory diagram showing a lottery table of displayed stopped symbols in the basic game;

FIG. 10 is a figure showing a stop display region of five variable display sections;

FIG. 11 is a figure showing a first pay line;

FIG. 12 is a figure showing a second pay line;

FIG. 13 is a figure showing a third pay line;

FIG. 14 is a figure showing a fourth pay line;

FIG. 15 is a figure showing a fifth pay line;

FIG. 16 is a figure showing a sixth pay line;

FIG. 17 is a figure showing a seventh pay line;

FIG. 18 is a figure showing an eighth pay line;

FIG. 19 is a figure showing a ninth pay line;

FIG. 20 is a figure showing a tenth pay line;

FIG. 21 is a figure showing an eleventh pay line;

FIG. 22 is a figure showing a twelfth pay line;

FIG. 23 is a figure showing a thirteenth pay line;

FIG. 24 is a figure showing a fourteenth pay line;

FIG. 25 is a figure showing a fifteenth pay line;

FIG. 26 is a figure showing a sixteenth pay line;

FIG. 27 is a figure showing a seventeenth pay line;

FIG. 28 is a figure showing an eighteenth pay line;

FIG. 29 is a figure showing a nineteenth pay line;

FIG. 30 is a figure showing a twentieth pay line;

FIG. 31 is a figure showing a twenty first pay line;

FIG. 32 is a figure showing a twenty second pay line;

FIG. 33 is a figure showing a twenty third pay line;

FIG. 34 is a figure showing a twenty fourth pay line;

FIG. 35 is a figure showing a twenty fifth pay line;

FIG. 36 is a flowchart of a main processing program;

FIG. 37 is a flowchart of a start reception processing program;

FIG. 38 is a flowchart of a lottery processing program;

FIG. 39 is a flowchart of a basic game processing program;

FIG. 40 is a flowchart of a free game processing program;

FIG. 41 is an explanatory diagram showing the lottery table of displayed stopped symbols in the basic game;

FIG. 42 is an explanatory diagram schematically showing symbol columns which are displayed variably by a stop display region in a bonus game;

FIG. 43 is an explanatory diagram showing the lottery table of displayed stopped symbols in the bonus game;

FIG. 44 is an explanatory diagram showing virtual reels used in the basic game;

FIG. 45 is a figure showing an example of a combination of symbols shown in a stop state on the variable display section in the bonus game;

FIG. 46 is a figure showing an example of a combination of symbols shown in a stop state on the variable display section in the bonus game; and

FIG. 47 is an explanatory diagram showing the lottery table of a displayed stopped symbol in the bonus game.

### DESCRIPTION OF THE PREFERRED EMBODIMENTS

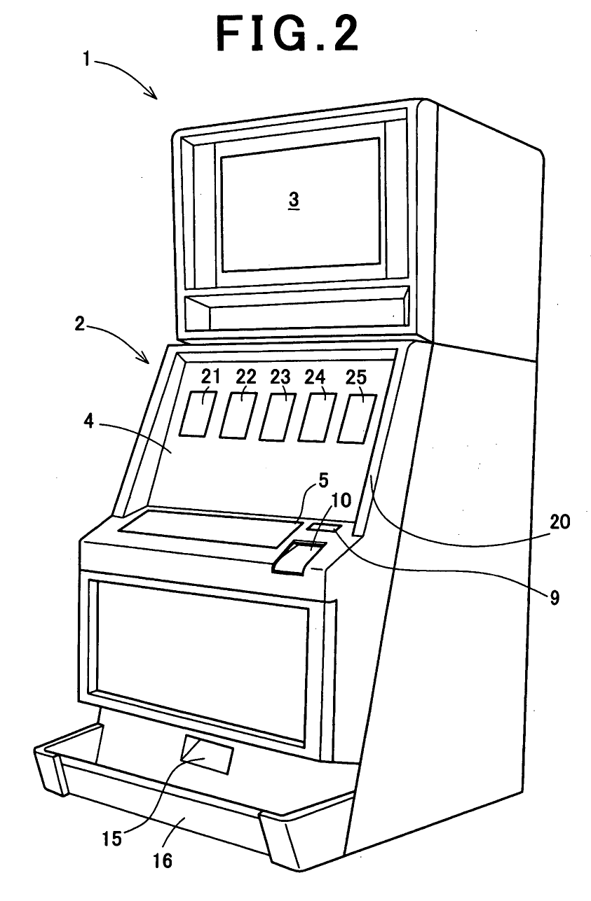

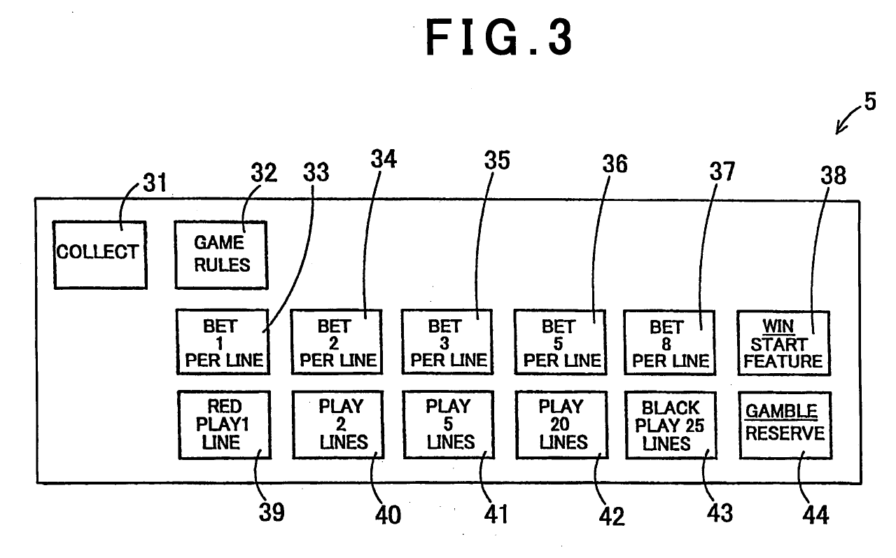

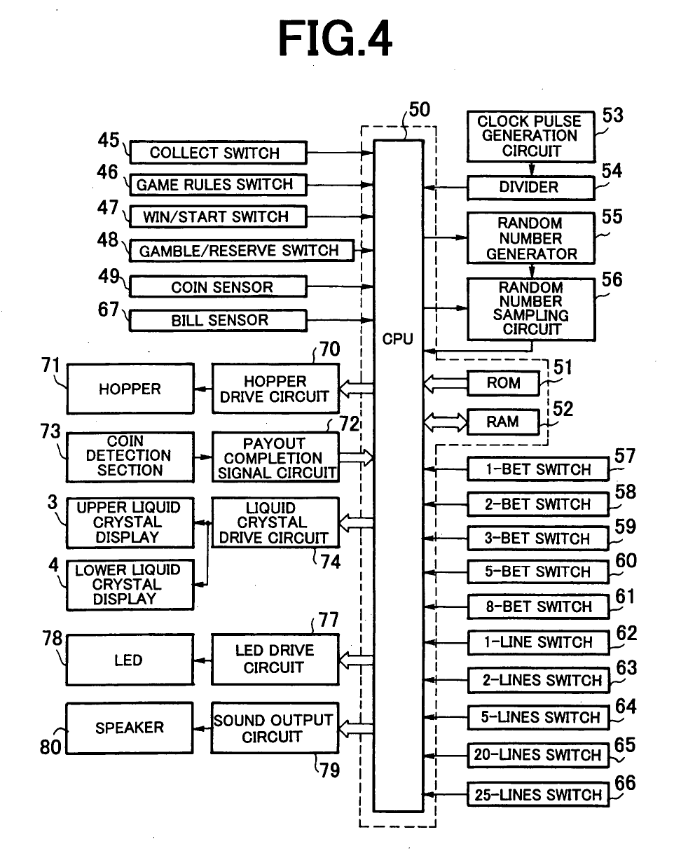

Hereinafter, the gaming machine of the present invention is described in detail with reference to the drawings on the basis of an embodiment in which the present invention is embodied into a slot machine. First, a schematic configuration of a slot machine according to the present embodiment is described on the basis of FIG. 2 through FIG. 4. FIG. 2 is a perspective view of the slot machine. FIG. 3 is a front view of a control panel. FIG. 4 is a block diagram which schematically shows a control system of the slot machine.

In FIG. 2, the slot machine 1 comprises a cabinet 2 which forms the entirety of the slot machine 1, wherein an upper liquid crystal display 3 is disposed in a front upper section of the cabinet 2, and a lower liquid crystal display 4 is disposed in an equipment front panel 20 provided in a front center section of the cabinet 2. Here, the upper liquid crystal display 3 is configured from a liquid crystal display which is used in general, and the lower liquid crystal display 4 is also configured from a liquid crystal display which is used in general. The upper liquid crystal display 3 displays information on a game, such as a game method, a type of a winning combination and its award, and various effects related to the game. The lower liquid crystal display 4 displays credit along with, basically, five variable display sections 21, 22, 23, 24, and 25 as shown in FIG. 2, wherein various symbols, which are described hereinafter, are displayed while scrolling from top to bottom and thereafter displayed in a stop state on the variable display sections 21 through 25 respectively.

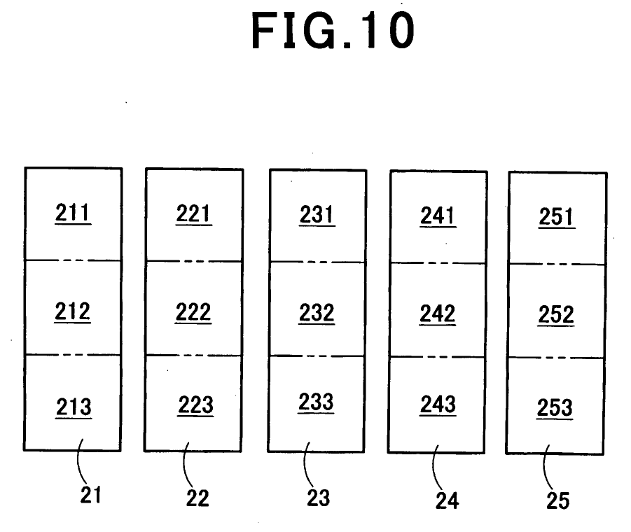

Therefore, in the slot machine 1 of the present embodiment, slot games (basic games and bonus games) are played with video reels which are realized by being displayed respectively via the variable display sections 21 through 25 of the lower liquid crystal display 4. In the slot games (basic games and bonus games), three symbols are displayed in a stop state on each of the variable display sections 21 through 25. Specifically, as shown in FIG. 10, the variable display sections 21 through 25 are respectively sectioned by first stop display regions 211, 221, 231, 241, and 251, second stop display regions 212, 222, 232, 242 and 252, and third stop display regions 213, 223, 233, 243, and 253, and symbols are displayed in a stop state in the stop display regions 211 through 213, 221 through 223, 231 through 233, 241 through 243, and 251 through 253.

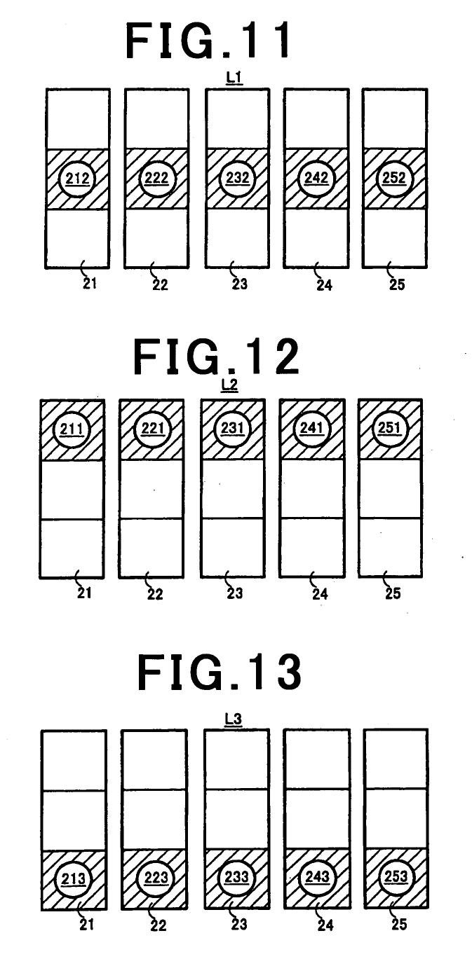

Furthermore, in the slot games (basic games and bonus games), there are twenty five pay lines formed by five of the stop display regions 211 through 213, 221 through 223, 231 through 233, 241 through 243, and 251 through 253. In each of the pay lines, if it is active, an award is provided when predetermined symbols are arranged and displayed in a predetermined pattern in a stop state. Here, the pay lines are described specifically with reference to FIG. 11 through FIG. 35. FIG. 11 through FIG. 35 are figures showing a single pay line with a shaded area.

Specifically, as shown in the shaded area in FIG. 11, a first pay line L1 is formed with the second stop display regions 212, 222, 232, 242, and 252.

Moreover, as shown in the shaded area in FIG. 12, a second pay line L2 is formed with the first stop display regions 211, 221, 231, 241, and 251.

As shown in the shaded area in FIG. 13, a third pay line L3 is formed with the third stop display regions 213, 223, 233, 243, and 253.

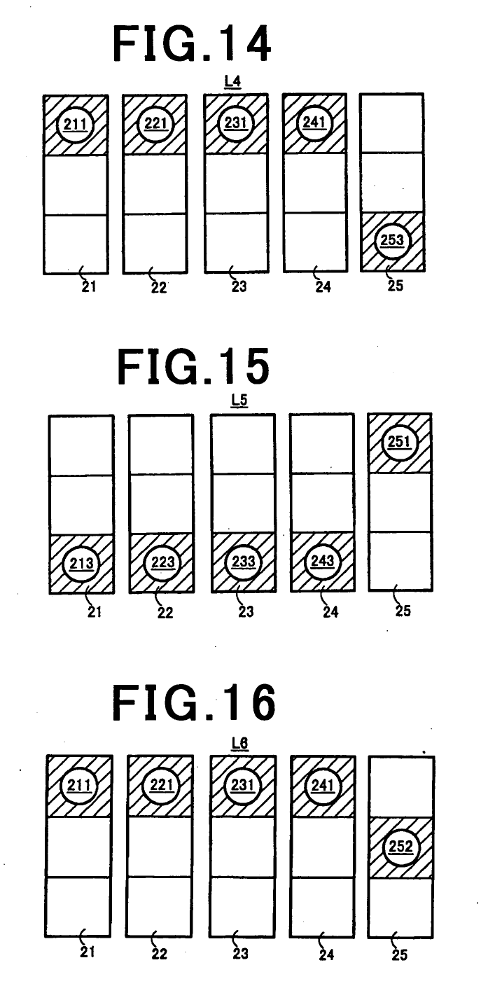

As shown in the shaded area in FIG. 14, a fourth pay line L4 is formed with the first stop display regions 211, 221, 231 and 241, and the third stop display region 253.

As shown in the shaded area in FIG. 15, a fifth pay line L5 is formed with the first stop display region 251, and the third stop display regions 213, 223, 233 and 243.

Furthermore, as shown in the shaded area in FIG. 16, a sixth pay line L6 is formed with the first stop display regions 211, 221, 231 and 241, and the second stop display region 252.

As shown in the shaded area in FIG. 17, a seventh pay line L7 is formed with the second stop display region 252 and the third stop display regions 213, 223, 233 and 243.

As shown in the shaded area in FIG. 18, an eighth pay line L8 is formed with the first stop display regions 211, 221, 231 and 251, and the second stop display region 242.

As shown in the shaded area in FIG. 19, a ninth pay line L9 is formed with the second stop display region 242 and the third stop display regions 213, 223, 233 and 253.

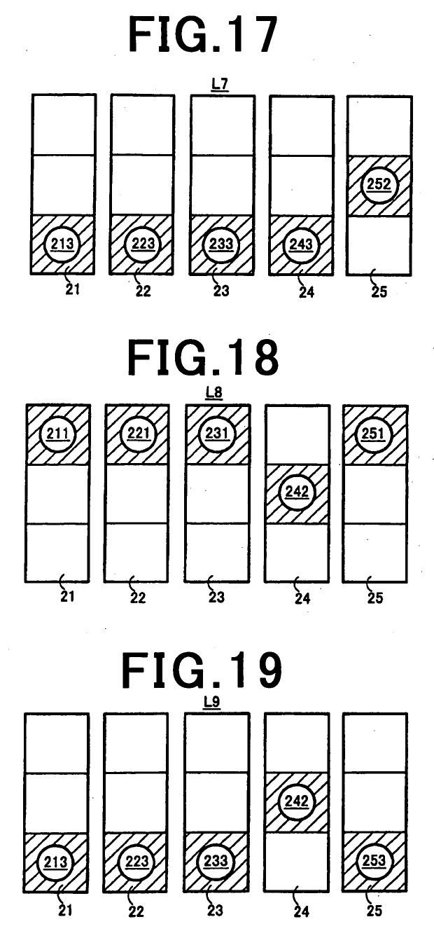

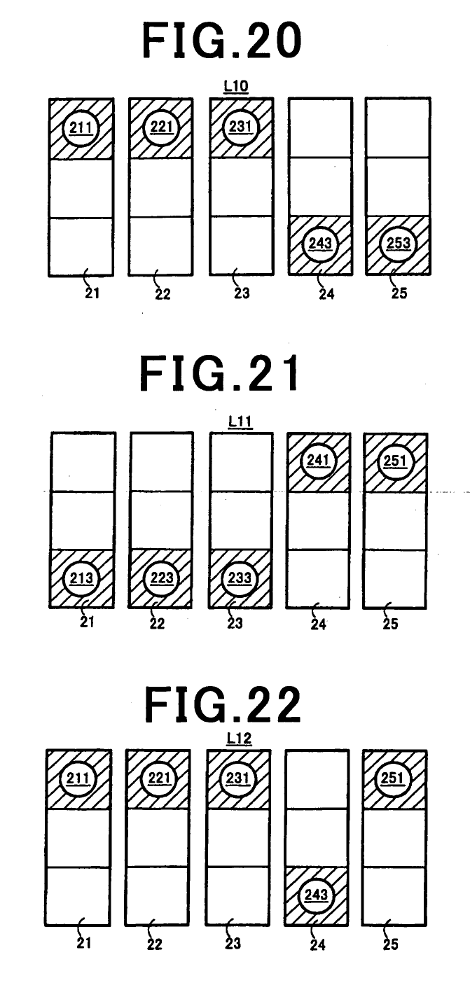

As shown in the shaded area in FIG. 20, a tenth pay line L10 is formed with the first stop display regions 211, 221 and 231, and the third stop display regions 243 and 253.

As shown in the shaded area in FIG. 21, an eleventh pay line L11 is formed with the first stop display regions 241 and 251, and the third stop display regions 213, 223 and 233.

As shown in the shaded area in FIG. 22, a twelfth pay line L12 is formed with the first stop display regions 211, 221, 231 and 251, and the third stop display region 243.

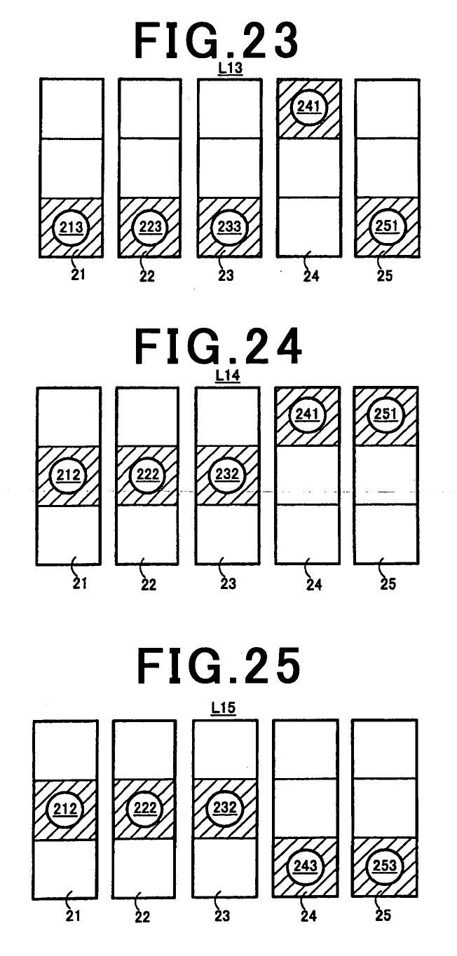

As shown in the shaded area in FIG. 23, a thirteenth pay line L13 is formed with the first stop display region 241 and the third stop display regions 213, 223, 233 and 253.

As shown in the shaded area in FIG. 24, a fourteenth pay line L14 is formed with the first stop display regions 241 and 251, and the second stop display regions 212, 222 and 232.

As shown in the shaded area in FIG. 25, a fifteenth pay line L15 is formed with the second stop display regions 212, 222 and 232, and the third stop display regions 243 and 253.

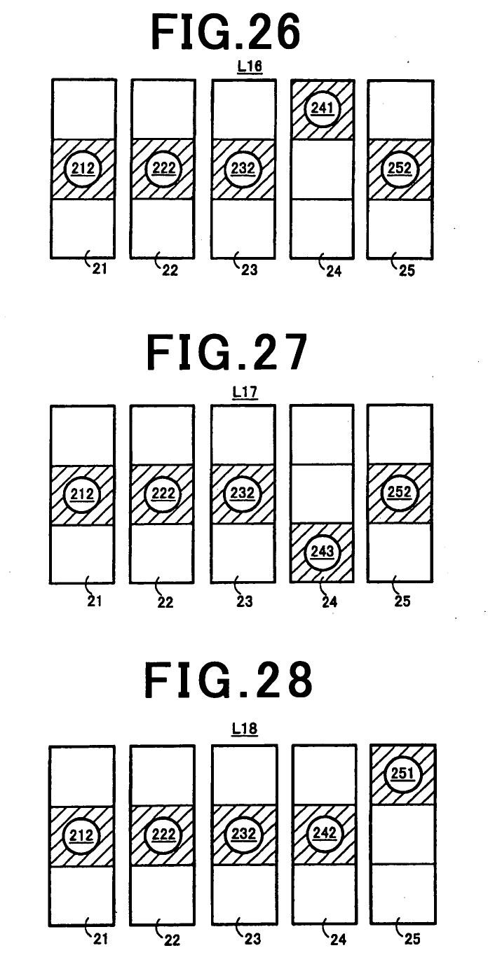

As shown in the shaded area in FIG. 26, a sixteenth pay line L16 is formed with the first stop display region 241 and the second stop display regions 212, 222, 232 and 252.

As shown in the shaded area in FIG. 27, a seventeenth pay line L17 is formed with the second stop display regions 212, 222, 232 and 252, and the third stop display region 243.

As shown in the shaded area in FIG. 28, an eighteenth pay line L18 is formed with the first stop display region 251 and the second stop display regions 212, 222, 232 and 242.

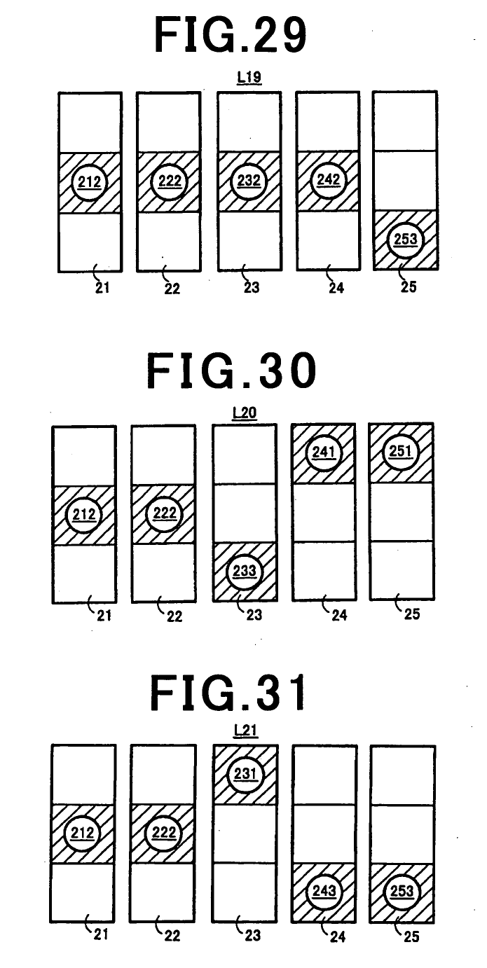

As shown in the shaded area in FIG. 29, a nineteenth pay line L19 is formed with the second stop display regions 212, 222, 232 and 242, and the third stop display region 253.

As shown in the shaded area in FIG. 30, a twentieth pay line L20 is formed with the first stop display regions 241 and 251, the second stop display regions 212 and 222, and the third stop display region 233.

As shown in the shaded area in FIG. 31, a twenty first pay line L21 is formed with the first stop display region 231, the second stop display regions 212 and 222, and the third stop display regions 243 and 253.

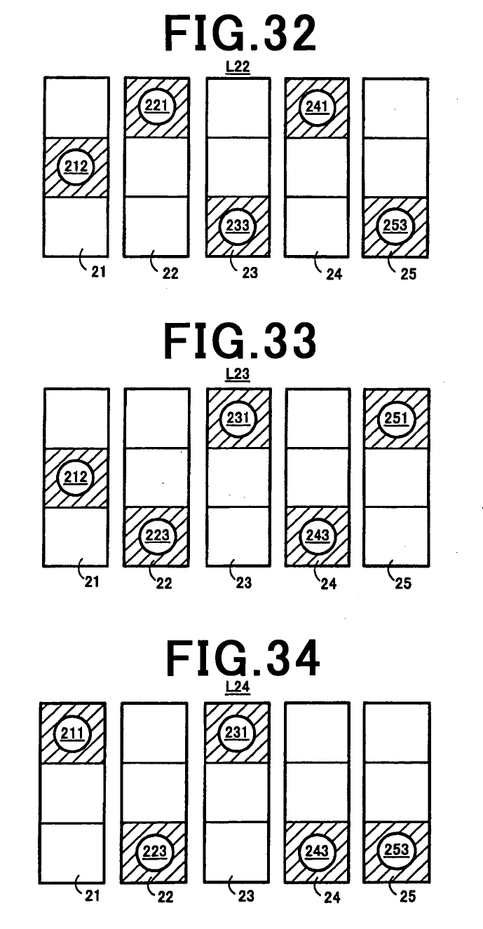

As shown in the shaded area in FIG. 32, a twenty second pay line L22 is formed with the first stop display regions 221 and 241, the second stop display region 212, and the third stop display regions 233 and 253.

As shown in the shaded area in FIG. 33, a twenty third pay line L23 is formed with the first stop display regions 231 and 251, the second stop display region 212, and the third stop display regions 223 and 243.

As shown in the shaded area in FIG. 34, a twenty fourth pay line L24 is formed with the first stop display regions 211 and 231, and the third stop display regions 223, 243 and 253.

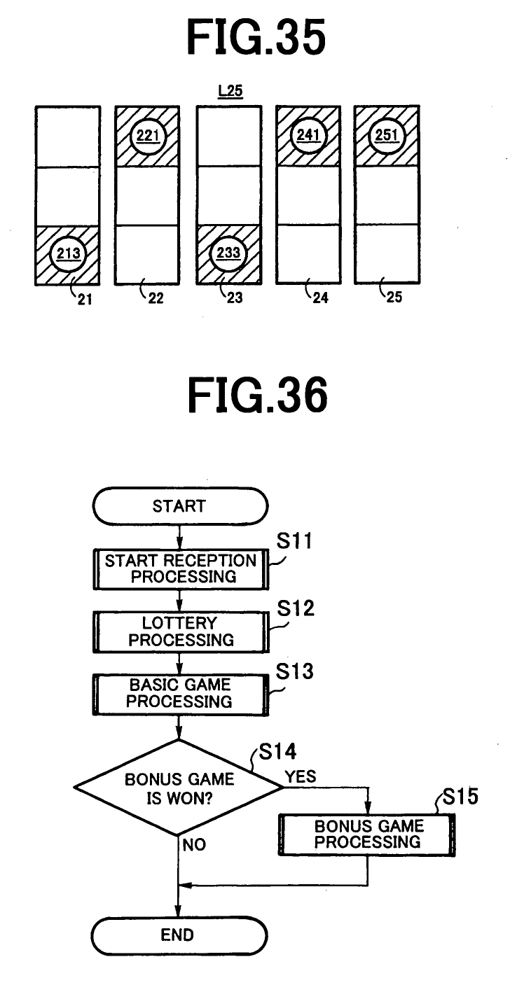

As shown in the shaded area in FIG. 35, a twenty fifth pay line L25 is formed with the first stop display regions 221, 241 and 251, and the third stop display regions 213 and 233.

It should be noted here that the active pay lines out of the twenty five pay lines are referred to as “active pay line”.

Returning to FIG. 2, a control panel 5 protruding forward is provided on a lower side of the lower liquid crystal display 4. In this regard, as shown in FIG. 3, a COLLECT button 31 and a GAME RULES button 32 are disposed from the leftmost side in a top stage of the control panel 5, a BET1 PER LINE button 33, a BET2 PER LINE button 34, a BET3 PER LINE button 35, a BET5 PER LINE button 36, a BET8 PER LINE button 37, and a WIN START FEATURE button 38 are disposed from the leftmost side in a middle stage, and a RED PLAY1 LINE button 39, a PLAY2 LINES button 40, a PLAY5 LINES button 41, PLAY20 LINES button 42, a BLACK PLAY25 LINES button 43, and a GAMBLE RESERVE button 44 are disposed from the leftmost side in a bottom stage. Further, as shown in FIG. 2, a coin insertion slot 9 and a bill insertion slot 10 are provided on the right side of the control panel 5.

Here, the COLLECT button 31 is pushed when ending a basic game. When the COLLECT button 31 is pushed, the number of coins equivalent to the number of credits acquired in the game are paid back from a coin payout opening 15 to a coin tray 16. It should be noted that a COLLECT switch 45 is annexed to the COLLECT button 31, and a signal is output to the CPU 50 upon pushing of the COLLECT button 31 (see FIG. 4).

The GAME RULES button 32 is pushed when an operation method and the like of the game is unclear. When the GAME RULES button 32 is pushed, various help information is displayed on the upper liquid crystal display 3 and lower liquid crystal display 4. A GAME RULES switch 46 is annexed to the GAME RULES button 32, and a signal is output from the GAME RULES switch 46 to the CPU 50 upon pushing of the GAME RULES button 32 (see FIG. 4).

A coin sensor 49 is disposed in a coin insertion slot 9. When coins are inserted into the coin insertion slot 9, a coin detection signal is output to the CPU 50 via the coin sensor 49 (see FIG. 4), and credits equivalent to the number of inserted coins are added up. Moreover, a bill sensor 67 is disposed in the bill insertion slot 10. When bills are inserted into the bill insertion slot 10, a bill detection signal is output to the CPU 50 via the bill sensor 67 (see FIG. 4), and credits equivalent to the number of inserted bills are added up.

Each time when the BET1 PER LINE 33 is pushed, a single bet is placed for each active pay line. A 1-BET switch 57 is annexed to this BET1 PER LINE button 33, and when the BET1 PER LINE button 33 is pushed a switch signal is output from the 1-BET switch 57 to the CPU 50 (see FIG. 4). The BET2 PER LINE button 34 is a button for starting a game with two bets for each active pay line upon pushing of the BET2 PER LINE button 34. A 2-BET switch 58 is annexed to the BET2 PER LINE button 34, and a switch signal is output from the 2-BET switch 58 to the CPU 50 when the BET2 PER LINE button 34 is pushed (see FIG. 4).

The BET3 PER LINE button 35 is a button for starting a game with three bets for each active pay line upon pushing of the BET3 PER LINE button 35. A 3-BET switch 59 is annexed to the BET3 PER LINE button 35, and a switch signal is output from the 3-BET switch 59 to the CPU 50 when the BET3 PER LINE button 35 is pushed (see FIG. 4). Moreover, the BET5 PER LINE button 36 is a button for starting a game with five bets for each active pay line upon pushing of the BET5 PER LINE button 36. A 5-BET switch 60 is annexed to the BET5 PER LINE button 36, and a switch signal is output from the 5-BET switch 60 to the CPU 50 when the BET5 PER LINE button 36 is pushed (see FIG. 4).

The BET8 PER LINE button 37 is a button for starting a game with eight bets for each active pay line upon pushing of the BET8 PER LINE button 37. An 8-BET switch 61 is annexed to the BET8 PER LINE button 37, and a switch signal is output from the 8-BET switch 61 to the CPU 50 when the BET8 PER LINE button 37 is pushed (see FIG. 4).

Therefore, 1, 2, 3, 5, and 8 bets can be placed by pushing the BET1 PER LINE button 33, BET2 PER LINE button 34, BET3 PER LINE button 35, BET5 PER LINE button 36, and BET8 PER LINE button 37.

The WIN START FEATURE button 38 is a button for starting a bonus game or adding the awards acquired in the bonus game to the credits. A WIN/START switch 47 is annexed to the WIN START FEATURE button 38, and a switch signal is output from the WIN/START switch 47 to the CPU 50 when the WIN START FEATURE button 38 is pushed (see FIG. 4).

The RED PLAY1 LINE button 39 is a button for starting a game with “1” active pay line upon pushing of the RED PLAY1 LINE button 39. A 1-LINE switch 62 is annexed to the RED PLAY1 LINE button 39, and a switch signal is output from the 1-LINE switch 62 to the CPU 50 upon pushing of the RED PLAY1 LINE button 39 (see FIG. 4). Moreover, the PLAY2 LINES button 40 is a button for starting a game with “2” active pay lines upon pushing of the PLAY2 LINES button 40. A 2-LINES switch 63 is annexed to the PLAY2 LINES button 40, and a switch signal is output from the 2-LINES switch 63 to the CPU 50 upon pushing of the PLAY2 LINES button 40 (see FIG. 4).

The PLAY5 LINES button 41 is a button for starting a game with “5” active pay lines upon pushing of the PLAY5 LINES button 41. A 5-LINES switch 64 is annexed to the PLAY5 LINES button 41, and a switch signal is output from the 5-LINES switch 64 to the CPU 50 upon pushing of the PLAY5 LINES button 41 (see FIG. 4). Furthermore, the PLAY20 LINES button 42 is a button for starting a game with “20” active pay lines upon pushing of the PLAY20 LINES button 42. A 20-LINES switch 65 is annexed to the PLAY20 LINES button 42, and a switch signal is output from the 20-LINES switch 65 to the CPU 50 upon pushing of the PLAY20 LINES button 42 (see FIG. 4).

The BLACK PLAY25 LINES button 43 is a button for starting a game with “25” active pay lines upon pushing of the BLACK PLAY25 LINES button 43. A 25-LINES switch 66 is annexed to the BLACK PLAY25 LINES button 43, and a switch signal is output from the 25-LINES switch 66 to the CPU 50 upon pushing of the BLACK PLAY25 LINES button 43 (see FIG. 4).

Therefore, “1”, “2”, “5”, “20” and “25” active pay lines can be determined by pushing the RED PLAY1 LINE button 39, PLAY2 LINES button 40, PLAY5 LINES button 41, PLAY20 LINES button 42, and BLACK PLAY25 LINES button 43.

In this regard, when the RED PLAY1 LINE button 39 is pushed, the pay line L1 shown in FIG. 11 is validated. Further, when the PLAY2 LINES button 40 is pushed, the pay lines L1 and L2 shown in FIG. 11 and FIG. 12 are validated. When the PLAY5 LINES button 41 is pushed, the pay lines L1 through L5 shown in FIG. 11 through FIG. 15 are validated. When the PLAY20 LINES button 42 is pushed, the pay lines L1 through L20 shown in FIG. 11 through FIG. 30 are validated. When the BLACK PLAY25 LINES button 43 is pushed, the pay lines L1 through L25 shown in FIG. 11 through FIG. 35 are validated.

Moreover, upon pushing of the RED PLAY1 LINE button 39, PLAY2 LINES button 40, PLAY5 LINES button 41, PLAY20 LINES button 42, and BLACK PLAY25 LINES button 43, variable display of each symbol is started by each of the variable display sections 21 through 25 of the lower liquid crystal display 4 in order to start a game with the current number of bets and the corresponding number of active pay lines.

It should be noted that the RED PLAY1 LINE button 39 and the BLACK PLAY25 LINES button 43 are also used when selecting red and black during a double down game which is played using the credits acquired in the bonus game.

The GAMBLE RESERVE button 44 is pushed when leaving seat and is used for shifting to the double down game after the bonus game is ended. A GAMBLE/RESERVE switch 48 is annexed to the GAMBLE RESERVE button 44, and a switch signal is output from the GAMBLE/RESERVE switch 48 to the CPU 50 upon pushing of the GAMBLE RESERVE button 44 (see FIG. 4).

In a lower part of the cabinet 2, the coin payout opening 15 is formed and the coin tray 16 for receiving the coins paid out from the coin payout opening 15 is provided. A coin detection section 73 configured from sensors and the like, which is described hereinafter, is disposed inside the coin payout opening 15 (see FIG. 4). The coin detection section 73 detects the number of coins paid out from the coin payout opening 15.

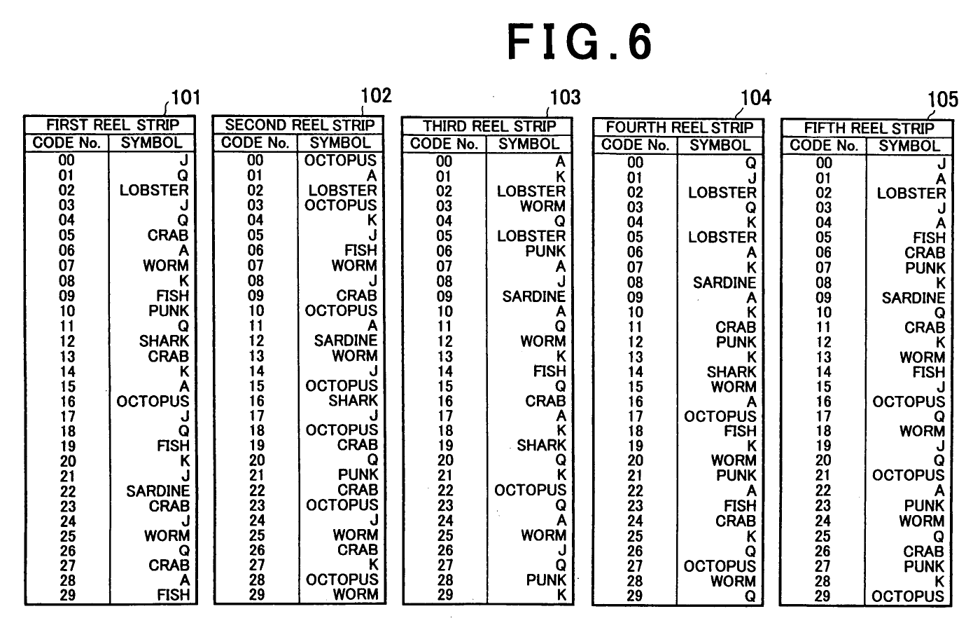

Next, FIG. 6 is used to explain an example of symbols displayed on the lower liquid crystal display 4 during the basic game and displayed variably while scrolling in each of the variable display sections 21 through 25. In FIG. 6, the column of symbols shown in the first reel strip 101 is a column of symbols displayed variably at the variable display section 21, the column of symbols shown in the second reel strip 102 is a column of symbols displayed variably at the variable display section 22, the column of symbols shown in the third reel strip 103 is a column of symbols displayed variably at the variable display section 23, the column of symbols shown in the fourth reel strip 104 is a column of symbols displayed variably at the variable display section 24, and the column of symbols shown in the fifth reel strip 105 is a column of symbols displayed variably at the variable display section 25.

Here, the columns of symbols shown in the reel strips 101 through 105 are arranged differently from one another, each column of symbols is constituted from appropriately combining twelve symbols of “LOBSTER”, “SHARK”, “FISH”, “PUNK”, “OCTOPUS”, “CRAB”, “WORM”, “A”, “K”, “Q”, “J”, and “SARDINE”.

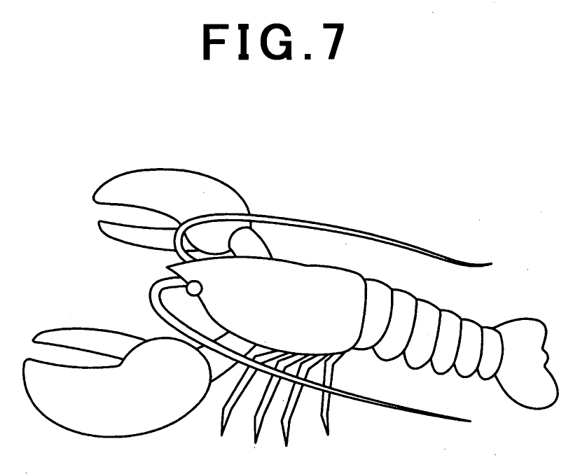

In this regard, “LOBSTER” shows a symbol of a lobster as shown in FIG. 7. Also, although not shown, “SHARK”, “FISH”, “PUNK”, “OCTOPUS”, “CRAB”, “WORM”, and “SARDINE” show symbols of a shark, fish, punk, octopus, crab, worm, and sardine respectively. “A”, “K”, “Q”, and “J” show symbols of alphabetic characters.

Moreover, as described hereinafter, “SARDINE” is a scattered symbol used for shifting to a bonus game, when total of three or more of this symbol are displayed in a stop state in the variable display sections 21 through 25, shifting to the bonus game can be performed regardless of the active pay lines.

It should be noted that when the columns of symbols shown in the reel strips 101 through 105 are displayed in a stop state after scrolled in each of the variable display sections 21 through 25, three symbols are displayed in a stop state in each of the variable display sections as described above.

Further, various winning combinations are set in advance on the basis of a plurality of types of the combination of symbols. When a combination of symbols corresponding to a winning combination stops on an active pay line, an award is added to the credit in response to the winning combination, which is same as a conventional slot machine, thus explanation in this regard is omitted here.

Next, a configuration related to a control system of the slot machine 1 is described on the basis of FIG. 4. FIG. 4 is a block diagram schematically showing the control system of the slot machine.

In FIG. 4, the control system of the slot machine 1 is constituted with the CPU 50 as a basic core, and a ROM 51 and a RAM 52 are connected to the CPU 50. The ROM 51 has stored therein a main processing program, a basic game processing program, a bonus game processing program, a lottery table for drawing a displayed stopped symbol of the basic game, a lottery table for drawing a displayed stopped symbol of the bonus game, other various programs required in control of the slot machine 1, a data table, and the like. The RAM 52 is a memory for temporarily storing various data computed by the CPU 50.

A clock pulse generation circuit 53 for generating a reference clock pulse, a divider (frequency divider) 54, a random number generator 55 for generating random numbers, and a random number sampling circuit 56 are connected to the CPU 50. Random numbers sampled by the random number sampling circuit 56 are used in various lotteries for drawing winning combinations and the like. Further, the COLLECT switch 45 annexed to the COLLECT button 31, the GAME RULES switch 46 annexed to the GAME RULES button 32, the 1-BET switch 57 annexed to the BET1 PER LINE button 33, the 2-BET switch 58 annexed to the BET2 PER LINE button 34, the 3-BET switch 59 annexed to the BET3 PER LINE button 35, the 5-BET switch 60 annexed to the BET5 PER LINE button 36, the 8-BET switch 61 annexed to the BET8 PER LINE button 37, the WIN/START switch 47 annexed to the WIN START FEATURE button 38, the 1-LINE switch 62 annexed to the RED PLAY1 LINE button 39, the 2-LINES switch 63 annexed to the PLAY2 LINES button 40, the 5-LINES switch 64 annexed to the PLAY5 LINES button 41, the 20-LINES switch 65 annexed to the PLAY20 LINES button 42, the 25-LINES switch 66 annexed to the BLACK PLAY25 LINES button 43, and the GAMBLE/RESERVE switch 48 annexed to the GAMBLE RESERVE button 44 are connected to the CPU 50. The CPU 50 performs control to execute various operations corresponding to each of the buttons on the basis of the switch signal which is output from each of the switches when each button is pushed.

Moreover, the coin sensor 49 disposed in the coin insertion slot 9 and the bill sensor 67 disposed in the bill insertion slot 10 are connected respectively to the CPU 50. The coin sensor 49 detects coins inserted through the coin insertion slot 9, and the CPU 50 computes the number of inserted coins on the basis of a coin detection signal output from the coin sensor 49. The bill sensor 67 detects the type and value of bills inserted through the bill insertion slot 10, and the CPU 50 computes the number of credits equivalent to the value of the bills on the basis of a bill detection signal output from the bill sensor 67.

A hopper 71 is connected to the CPU 50 via a hopper drive circuit 70. When a drive signal is output to the hopper drive circuit 70 from the CPU 50, the hopper 71 pays out a predetermined number of coins from the coin payout opening 15.

Furthermore, a coin detection section 73 is connected to the CPU 50 via a payout completion signal circuit 72. The coin detection section 73 is disposed inside the coin payout opening 15. When it is detected that a predetermined number of coins are paid out from the coin payout opening 15, a coin payout detection signal is output to the payout completion signal circuit 72 from the coin detection section 73. On the basis of this output coin payout detection signal, the payout completion signal circuit 72 outputs a payout completion signal to the CPU 50. Moreover, the upper liquid crystal display 3 and lower liquid crystal display 4 are connected to the CPU 50 via a liquid crystal drive circuit 74, thus the CPU 50 controls the upper liquid crystal display 3 and lower liquid crystal display 4.

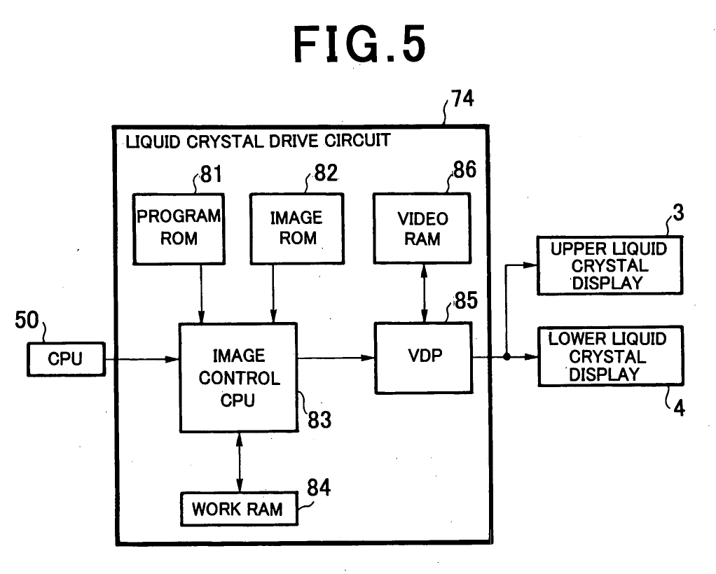

In this regard, as shown in FIG. 5, the liquid crystal drive circuit 74 is constituted from a program ROM 81, an image ROM 82, an image control CPU 83, a work RAM 84, a VDP (video display processor) 85, a video RAM 86, and the like. The program ROM 81 stores an image control program and various selection tables related to the display on the upper liquid crystal display 3 or lower liquid crystal display 4. The image ROM 82 stores dot data for forming images, such as the symbol columns shown in the reel strips 101 through 105 of FIG. 6 displayed on, for example, the lower liquid crystal display 4 (or the variable display sections 21 through 25). The image control CPU 83 determines an image to be displayed on the upper liquid crystal display 3 or lower liquid crystal display 4 from among the dot data stored beforehand in the image ROM 82, on the basis of parameters set by the CPU 50 and in accordance with the image control program stored beforehand in the program ROM 81. The work RAM 84 is configured as temporary storage means when the image control program is executed by the image control CPU 83. The VDP 85 creates an image corresponding to the display content determined by the image control CPU 83, and outputs the image to the upper liquid crystal display 3 or lower liquid crystal display 4. Accordingly, for example, the symbol columns shown in the reel strips 101 through 105 and the like are scrolled and displayed on the lower liquid crystal display 4 (or the variable display sections 21 through 25). It should be noted that the video RAM 86 is configured as temporary storage means when an image is formed by the VDP 85.

An LED 78 is connected to the CPU 50 via an LED drive circuit 77. A number of LEDs 78 are disposed on the front surface of the slot machine 1 and controlled to be illuminated by the LED drive circuit 77 on the basis of a drive signal from the CPU 50, when various effects are executed. Further, a sound output circuit 79 and a speaker 80 are connected to the CPU 50. The speaker 80 generates various sound effects on the basis of an output signal from the sound output circuit 79, when various effects are executed.

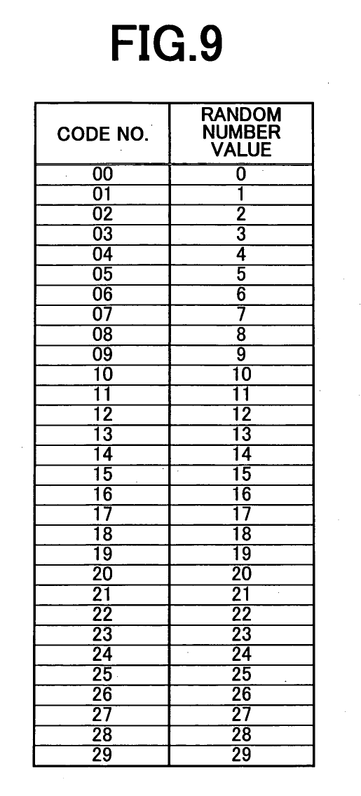

Here, FIG. 9 is used to describe a lottery table which is used when determining symbols to be displayed in a stop state on the active pay line L1 shown in FIG. 11, when the basic game is played using the five variable display sections 21 through 25 in the slot machine 1. FIG. 9 is an explanatory diagram showing the lottery table of a displayed stopped symbol when the basic game is played using the five variable display sections.

In this regard, a symbol to be displayed in a stop state on the active pay line L1 shown in FIG. 11 is determined for each of the variable display sections 21 through 25. To that end, the lottery table shown in FIG. 9 is provided beforehand while allocating code numbers “00” through “29” beginning at the top respectively to the symbol columns which are scrolled to be displayed in the variable display sections 21 through 25 respectively and shown in the reel strips 101 through 105 of FIG. 6. Then, five random numbers corresponding to the variable display sections 21 through 25 respectively are sampled via the random number sampling circuit 56.

Hereinafter, regarding the symbol column which is scrolled to be displayed in the variable display section 21 and displayed in the first reel strip 101 shown in FIG. 6, when at this moment the random number value sampled via the random number sampling circuit 56 is “0”, the symbol of “J” (alphabetic character), which is allocated to the code No. “00”, is displayed in a stop state on the active pay line L1 shown in FIG. 11. When the random number value is “1”, the symbol of “Q” (alphabetic character), which is allocated to the code No. “01”, is displayed in a stop state on the active pay line L1 shown in FIG. 11. When the random number value is “2”, the symbol of “LOBSTER” (the lobster shown in FIG. 7), which is allocated to the code No. “02”, is displayed in a stop state on the active pay line L1 shown in FIG. 11. When the random number value is “3”, the symbol of “J” (alphabetic character), which is allocated to the code No. “03”, is displayed in a stop state on the active pay line L1 shown in FIG. 11. When the random number value is “4”, the symbol of “Q” (alphabetic character), which is allocated to the code No. “04”, is displayed in a stop state on the active pay line L1 shown in FIG. 11. When the random number value is “5”, the symbol of “CRAB” (crab), which is allocated to the code No. “05”, is displayed in a stop state on the active pay line L1 shown in FIG. 11. When the random number value is “6”, the symbol of “A” (alphabetic character), which is allocated to the code No. “06”, is displayed in a stop state on the active pay line L1 shown in FIG. 11. When the random number value is “7”, the symbol of “WORM” (worm), which is allocated to the code No. “07”, is displayed in a stop state on the active pay line L1 shown in FIG. 11. When the random number value is “8”, the symbol of “K” (alphabetic character), which is allocated to the code No. “08”, is displayed in a stop state on the active pay line L1 shown in FIG. 11. When the random number value is “9”, the symbol of “FISH” (fish), which is allocated to the code No. “09”, is displayed in a stop state on the active pay line L1 shown in FIG. 11. When the random number value is “10”, the symbol of “PUNK” (punk), which is allocated to the code No. “10”, is displayed in a stop state on the active pay line L1 shown in FIG. 11.

Further, when the random number value is “11”, the symbol of “Q” (alphabetic character), which is allocated to the code No. “11”, is displayed in a stop state on the active pay line L1 shown in FIG. 11. When the random number value is “12”, the symbol of “SHARK” (shark), which is allocated to the code No. “12”, is displayed in a stop state on the active pay line L1 shown in FIG. 11. When the random number value is “13”, the symbol of “CRAB” (crab), which is allocated to the code No. “13”, is displayed in a stop state on the active pay line L1 shown in FIG. 11. When the random number value is “14”, the symbol of “K” (alphabetic character), which is allocated to the code No. “14”, is displayed in a stop state on the active pay line L1 shown in FIG. 11. When the random number value is “15”, the symbol of “A” (alphabetic character), which is allocated to the code No. “15”, is displayed in a stop state on the active pay line L1 shown in FIG. 11. When the random number value is “16”, the symbol of “OCTOPUS” (octopus), which is allocated to the code No. “16”, is displayed in a stop state on the active pay line L1 shown in FIG. 11. When the random number value is “17”, the symbol of “J” (alphabetic character), which is allocated to the code No. “17”, is displayed in a stop state on the active pay line L1 shown in FIG. 11. When the random number value is “18”, the symbol of “Q” (alphabetic character), which is allocated to the code No. “18, is displayed in a stop state on the active pay line L1 shown in FIG. 11. When the random number value is “19”, the symbol of “FISH” (fish), which is allocated to the code No. “19”, is displayed in a stop state on the active pay line L1 shown in FIG. 11.

Moreover, when the random number value is “20”, the symbol of “K” (alphabetic character), which is allocated to the code No. “20”, is displayed in a stop state on the active pay line L1 shown in FIG. 11. When the random number value is “21”, the symbol of “J” (alphabetic character), which is allocated to the code No. “21”, is displayed in a stop state on the active pay line L1 shown in FIG. 11. When the random number value is “22”, the symbol of “SARDINE” (sardine), which is allocated to the code No. “22”, is displayed in a stop state on the active pay line L1 shown in FIG. 11. When the random number value is “23”, the symbol of “CRAB” (crab), which is allocated to the code No. “23”, is displayed in a stop state on the active pay line L1 shown in FIG. 11. When the random number value is “24”, the symbol of “J” (alphabetic character), which is allocated to the code No. “24”, is displayed in a stop state on the active pay line L1 shown in FIG. 11. When the random number value is “25”, the symbol of “WORM” (worm), which is allocated to the code No. “25”, is displayed in a stop state on the active pay line L1 shown in FIG. 11. When the random number value is “26”, the symbol of “Q” (alphabetic character), which is allocated to the code No. “26”, is displayed in a stop state on the active pay line L1 shown in FIG. 11. When the random number value is “27”, the symbol of “CRAB” (crab), which is allocated to the code No. “27”, is displayed in a stop state on the active pay line L1 shown in FIG. 11. When the random number value is “28”, the symbol of “A” (alphabetic character), which is allocated to the code No. “28”, is displayed in a stop state on the active pay line L1 shown in FIG. 11. When the random number value is “29”, the symbol of “FISH” (fish), which is allocated to the code No. “29”, is displayed in a stop state on the active pay line L1 shown in FIG. 11.

It should be noted that such control is performed in the same manner for the symbol column of the second reel strip 102 of FIG. 6, which is scrolled to be displayed in the variable display section 22, the symbol column of the third reel strip 103 of FIG. 6, which is scrolled to be displayed in the variable display section 23, the symbol column of the fourth reel strip 104 of FIG. 6, which is scrolled to be displayed in the variable display section 24, and the symbol column of the fifth reel strip 105 of FIG. 6, which is scrolled to be displayed in the variable display section 25.

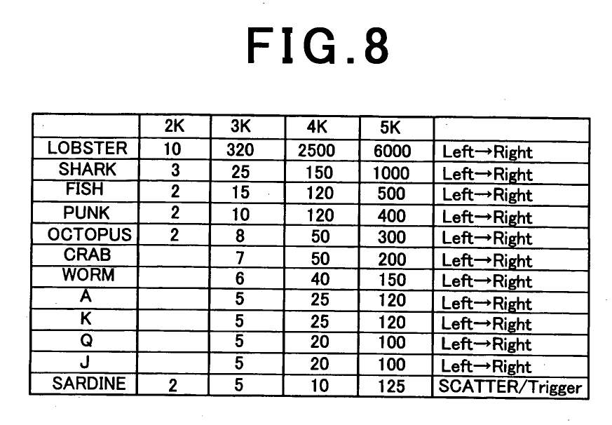

Next, a winning combination and its award when playing the basic game using the five variable display sections 21 through 25 in the slot machine 1 are described based on FIG. 8. FIG. 8 is an explanatory diagram showing a winning combination and its award when playing the basic game using the five variable display sections, and shows a case in which the number of bets is “1”. Therefore, when the number of bets is “1”, the awards shown in FIG. 8 are added to a credit, but when the number of bets is “2” or more, the numbers obtained by multiplying the values of the awards shown in FIG. 8 by the number of bets are added to credits.

Here, a winning combination and its award when playing the basic game are described specifically. For the symbol of “LOBSTER” (the lobster shown in FIG. 7), an award of “10” is obtained when this symbol is displayed in a stop state in succession on the active pay line in the variable display sections 21 and 22 (in the case of two, “2K”, which appear in succession from the left end), as shown in FIG. 8. Further, an award of “320” is obtained when this symbol is displayed in a stop state in succession on the active pay line in the variable display sections 21 through 23 (in the case of three, “3K”, which appear in succession from the left end). An award of “2500” is obtained when this symbol is displayed in a stop state in succession on the active pay line in the variable display sections 21 through 24 (in the case of four, “4K”, which appear in succession from the left end). An award of “6000” is obtained when this symbol is displayed in a stop state in succession on the active pay line in the variable display sections 21 through 25 (in the case of five, “5K”, which appear in succession from the left end).

For the symbol of “SHARK” (shark), an award of “3” is obtained when this symbol is displayed in a stop state in succession on the active pay line in the variable display sections 21 and 22 (in the case of two, “2K”, which appear in succession from the left end). Further, an award of “25” is obtained when this symbol is displayed in a stop state in succession on the active pay line in the variable display sections 21 through 23 (in the case of three, “3K”, which appear in succession from the left end). An award of “150” is obtained when this symbol is displayed in a stop state in succession on the active pay line in the variable display sections 21 through 24 (in the case of four, “4K”, which appear in succession from the left end). An award of “1000” is obtained when this symbol is displayed in a stop state in succession on the active pay line in the variable display sections 21 through 25 (in the case of five, “5K”, which appear in succession from the left end).

For the symbol of “FISH” (fish), an award of “2” is obtained when this symbol is displayed in a stop state in succession on the active pay line in the variable display sections 21 and 22 (in the case of two, “2K”, which appear in succession from the left end). Further, an award of “15” is obtained when this symbol is displayed in a stop state in succession on the active pay line in the variable display sections 21 through 23 (in the case of three, “3K”, which appear in succession from the left end). An award of “120” is obtained when this symbol is displayed in a stop state in succession on the active pay line in the variable display sections 21 through 24 (in the case of four, “4K”, which appear in succession from the left end). An award of “500” is obtained when this symbol is displayed in a stop state in succession on the active pay line in the variable display sections 21 through 25 (in the case of five, “5K”, which appear in succession from the left end).

For the symbol of “PUNK” (punk), an award of “2” is obtained when this symbol is displayed in a stop state in succession on the active pay line in the variable display sections 21 and 22 (in the case of two, “2K”, which appear in succession from the left end). Further, an award of “10” is obtained when this symbol is displayed in a stop state in succession on the active pay line in the variable display sections 21 through 23 (in the case of three, “3K”, which appear in succession from the left end). An award of “120” is obtained when this symbol is displayed in a stop state in succession on the active pay line in the variable display sections 21 through 24 (in the case of four, “4K”, which appear in succession from the left end). An award of “400” is obtained when this symbol is displayed in a stop state in succession on the active pay line in the variable display sections 21 through 25 (in the case of five, “5K”, which appear in succession from the left end).

For the symbol of “OCTOPUS” (octopus), an award of “2” is obtained when this symbol is displayed in a stop state in succession on the active pay line in the variable display sections 21 and 22 (in the case of two, “2K”, which appear in succession from the left end). Further, an award of “8” is obtained when this symbol is displayed in a stop state in succession on the active pay line in the variable display sections 21 through 23 (in the case of three, “3K”, which appear in succession from the left end). An award of “50” is obtained when this symbol is displayed in a stop state in succession on the active pay line in the variable display sections 21 through 24 (in the case of four, “4K”, which appear in succession from the left end). An award of “300” is obtained when this symbol is displayed in a stop state in succession on the active pay line in the variable display sections 21 through 25 (in the case of five, “5K”, which appear in succession from the left end).

For the symbol of “CRAB” (crab), an award of “7” is obtained when this symbol is displayed in a stop state in succession on the active pay line in the variable display sections 21 through 23 (in the case of three, “3K”, which appear in succession from the left end). An award of “50” is obtained when this symbol is displayed in a stop state in succession on the active pay line in the variable display sections 21 through 24 (in the case of four, “4K”, which appear in succession from the left end). An award of “200” is obtained when this symbol is displayed in a stop state in succession on the active pay line in the variable display sections 21 through 25 (in the case of five, “5K”, which appear in succession from the left end).

For the symbol of “WORM” (worm), an award of “6” is obtained when this symbol is displayed in a stop state in succession on the active pay line in the variable display sections 21 through 23 (in the case of three, “3K”, which appear in succession from the left end). An award of “40” is obtained when this symbol is displayed in a stop state in succession on the active pay line in the variable display sections 21 through 24 (in the case of four, “4K”, which appear in succession from the left end). An award of “150” is obtained when this symbol is displayed in a stop state in succession on the active pay line in the variable display sections 21 through 25 (in the case of five, “5K”, which appear in succession from the left end).

For the symbol of “A” (alphabetic character), an award of “5” is obtained when this symbol is displayed in a stop state in succession on the active pay line in the variable display sections 21 through 23 (in the case of three, “3K”, which appear in succession from the left end). An award of “25” is obtained when this symbol is displayed in a stop state in succession on the active pay line in the variable display sections 21 through 24 (in the case of four, “4K”, which appear in succession from the left end). An award of “120” is obtained when this symbol is displayed in a stop state in succession on the active pay line in the variable display sections 21 through 25 (in the case of five, “5K”, which appear in succession from the left end).

For the symbol of “K” (alphabetic character), an award of “5” is obtained when this symbol is displayed in a stop state in succession on the active pay line in the variable display sections 21 through 23 (in the case of three, “3K”, which appear in succession from the left end). An award of “25” is obtained when this symbol is displayed in a stop state in succession on the active pay line in the variable display sections 21 through 24 (in the case of four, “4K”, which appear in succession from the left end). An award of “120” is obtained when this symbol is displayed in a stop state in succession on the active pay line in the variable display sections 21 through 25 (in the case of five, “5K”, which appear in succession from the left end).

For the symbol of “Q” (alphabetic character), an award of “5” is obtained when this symbol is displayed in a stop state in succession on the active pay line in the variable display sections 21 through 23 (in the case of three, “3K”, which appear in succession from the left end). An award of “20” is obtained when this symbol is displayed in a stop state in succession on the active pay line in the variable display sections 21 through 24 (in the case of four, “4K”, which appear in succession from the left end). An award of “100” is obtained when this symbol is displayed in a stop state in succession on the active pay line in the variable display sections 21 through 25 (in the case of five, “5K”, which appear in succession from the left end).

For the symbol of “J” (alphabetic character), an award of “5” is obtained when this symbol is displayed in a stop state in succession on the active pay line in the variable display sections 21 through 23 (in the case of three, “3K”, which appear in succession from the left end). An award of “20” is obtained when this symbol is displayed in a stop state in succession on the active pay line in the variable display sections 21 through 24 (in the case of four, “4K”, which appear in succession from the left end). An award of “100” is obtained when this symbol is displayed in a stop state in succession on the active pay line in the variable display sections 21 through 25 (in the case of five, “5K”, which appear in succession from the left end).

If the awards obtained from these symbols are on a plurality of active pay lines, the total of all these awards are added to credits.

On the other hand, for the symbol of “SARDINE” (sardine), in the variable display sections 21 through 25 an award of “2” is obtained in the case of two, “2K”, which appear (displayed in a stop state), regardless of the active pay line, an award of “5” is obtained in the case of three, “3K”, which appear (or are displayed in a stop state), regardless of the active pay line, an award of “10” is obtained in the case of four, “4K”, which appear (or are displayed in a stop state), regardless of the active pay line, and an award of “125” is obtained in the case of five, “5K”, which appear (or are displayed in a stop state), regardless of the active pay line.

It should be noted that, only for the awards obtained in the case of the symbol of “SARDINE” (sardine), the number obtained by multiplying the total number of bets by the value of the awards shown in FIG. 8 (product of the number of bets and the number of active pay lines) is added to credits. At this moment, the awards obtained in the case of the symbols other than the symbol of “SARDINE” (sardine) are also added to the credits.

Also, in the variable display sections 21 through 25, when the total of three or more of the symbol of “SARDINE” (sardine) appear (or are displayed in a stop state) regardless of the active pay line, the abovementioned award can be obtained and the game can be shifted to the bonus game.

The bonus game is played after the basic game is played, and is generally advantageous to a player most of the time. Here, once shifting to the bonus game, fifteen through twenty five games are played automatically in response to a lottery result obtained when shifting to the bonus game, without betting credits and the like.

It should be noted that, in the bonus game, the number of bets and the number of active pay lines obtained when shifting to the bonus game are used.

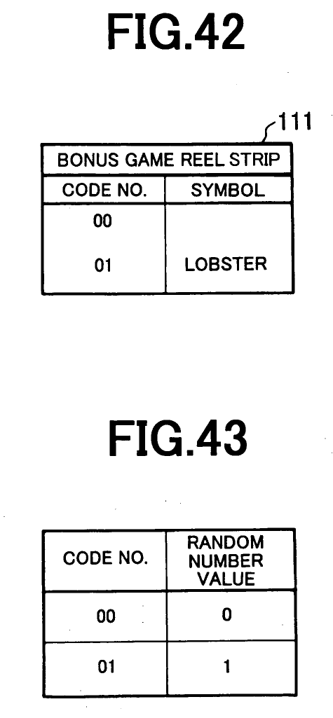

Next, FIG. 42 is used to describe examples of symbols which are displayed on the lower liquid crystal display 4 during the bonus game and are variably displayed while scrolling on the stop display regions 211 through 213, 221 through 223, 231 through 233, 241 through 243, and 251 through 253 of the variable display section 21 through 25 respectively. In FIG. 42, the example of a symbol shown in the bonus game reel strip 111 is variably displayed in the stop display regions 211 through 213, 221 through 223, 231 through 233, 241 through 243, and 251 through 253. Specifically, in the bonus game here, the example of the symbol shown in the bonus game reel strip 111 is variably displayed while scrolling on each of the stop display regions 211 through 213, 221 through 223, 231 through 233, 241 through 243, and 251 through 253 in each of the variable display sections 21 through 25 of the lower liquid crystal display 4.

Here, the example of the symbol shown in the bonus game reel strip 111 is constituted from two symbols of a blank symbol and “LOBSTER”. In this regard, no symbol is shown in the blank symbol, and “LOBSTER” is a symbol of the lobster used in the basic game, as shown in FIG. 7.

Next, FIG. 43 is used to describe the lottery table which is used for determining the symbols to be displayed in a stop state on the stop display regions 211 through 213, 221 through 223, 231 through 233, 241 through 243, and 251 through 253 respectively, when playing the bonus game using the stop display regions 211 through 213, 221 through 223, 231 through 233, 241 through 243, and 251 through 253 in the slot machine 1. FIG. 43 is an explanatory diagram showing the lottery table of displayed stopped symbols when playing the bonus game using the stop display regions 211 through 213, 221 through 223, 231 through 233, 241 through 243, and 251 through 253.

In this regard, the symbols which are displayed in a stop state on the stop display regions 211 through 213, 221 through 223, 231 through 233, 241 through 243, and 251 through 253 are determined for the stop display regions 211 through 213, 221 through 223, 231 through 233, 241 through 243, and 251 through 253 respectively. To that end, the lottery table shown in FIG. 43 is provided beforehand while allocating code numbers “00” through “01” beginning at the top respectively to the symbol columns which are scrolled to be displayed in the stop display regions 211 through 213, 221 through 223, 231 through 233, 241 through 243, and 251 through 253 respectively and shown in the bonus game reel strip 111 of FIG. 42. Then, fifteen random numbers corresponding to the stop display regions 211 through 213, 221 through 223, 231 through 233, 241 through 243, and 251 through 253 respectively are sampled via the random number sampling circuit 56.

Hereinafter, regarding the symbol column which is scrolled to be displayed in the stop display region 211 and displayed in the bonus game reel strip 111 shown in FIG. 42, when at this moment the random number value sampled via the random number sampling circuit 56 is “0”, the blank symbol, which is allocated to the code No. “00”, is displayed in a stop state, and when the random number value is “1”, the symbol of “LOBSTER” (the lobster shown in FIG. 7), which is allocated to the code No. “01”, is displayed in a stop state on the active pay line L1 shown in FIG. 11.

It should be noted that such control is performed in the same manner for the symbol column of the bonus game reel strip 111 of FIG. 42, which is scrolled to be displayed in the stop display regions 212, 213, 221 through 223, 231 through 233, 241 through 243, and 251 through 253.

A winning combination and its award in the bonus game are same as those in the basic game described above. Therefore, since the probability that the symbol of “LOBSTER” (the lobster shown in FIG. 7) appears in each of the stop display regions 211 through 213, 221 through 223, 231 through 233, 241 through 243, and 251 through 253 is as high as “1/2”, the player can often acquire a large number of credits and the like (see FIG. 8).

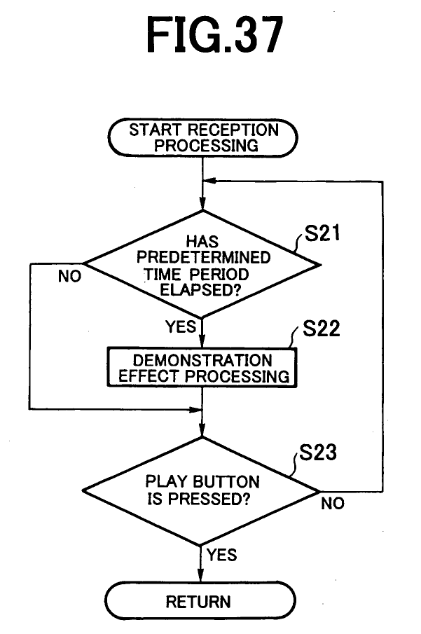

Next, the main processing program performed in the slot machine 1 is described with reference to FIG. 36. FIG. 36 is a flowchart of the main processing program. In FIG. 36, first of all, start reception processing shown in FIG. 37, which is described hereinafter, is performed in a step (abbreviated as “S” hereinafter) 11. This processing is for receiving switch signals, which are output from the 1-BET switch 57, 2-BET switch 58, 3-BET switch 59, 5-BET switch 60, 8-BET switch 60, 1-LINE switch 62, 2-LINES switch 63, 5-LINES switch 64, 20-LINES switch 65, or 25-LINES switch 66, on the basis of the operation of the BET1 PER LINE button 33, the operation of the BET2 PER LINE button 34, the operation of the BET3 PER LINE button 35, the operation of the BET5 PER LINE button 36, the operation of the BET8 PER LINE button 37, the operation of the RED PLAY1 LINE button 39, the operation of the PLAY2 LINES button 40, the operation of the PLAY5 LINES button 41, the operation of the PLAY20 LINES button 42, or the operation of the BLACK PLAY25 LINES button 43. At the point of time when the switch signals output from the respective switches are received, a game is started.

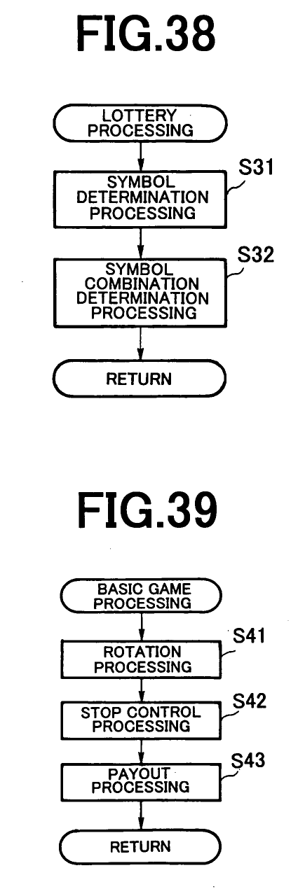

Then, in S12, lottery processing shown in FIG. 38, which is described hereinafter, is performed on the basis of the switch signals which are output from the 1-LINE switch 62, 2-LINES switch 63, 5-LINES switch 64, 20-LINES switch 65, and 25-LINES switch 66.

It should be noted here that when winning a bonus game, the number of times the bonus game is repeated is determined, and a game is selected by lot from, for example, ten through twenty five games.

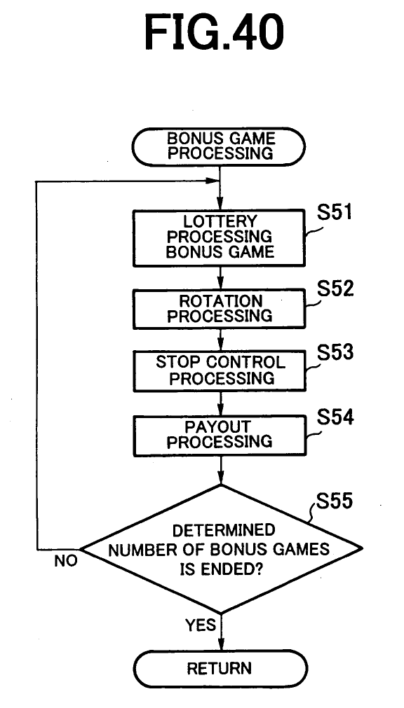

Basic game processing shown in FIG. 39, which is described hereinafter, is performed in S13. Thereafter, the step proceeds to S14 to determine whether the bonus game is won. To be concrete, in the lottery processing of S12, when the total of three or more of the symbol of “SARDINE” (sardine) appear (or are displayed in a stop state) in the variable display sections 21 through 25 regardless of the active pay line, the bonus game is won (S14: YES), the step proceeds to S15 to perform bonus game processing shown in FIG. 40, which is described hereinafter, and thereafter the main processing program is ended. On the other hand, in the lottery processing of S12, when the total of three or more of the symbol of “SARDINE” (sardine) do not appear (or are not displayed in a stop state) in the variable display sections 21 through 25 regardless of the active pay line, the bonus game is not won (S14: NO), thus the main processing program is ended.

Next, the start reception processing program performed in the slot machine 1 is described based on FIG. 37. FIG. 37 is a flowchart of the start reception processing program. In S11 of the main processing program shown in FIG. 36, the start reception processing is performed. To this end, first, the step proceeds to S21 of FIG. 37 where it is determined whether predetermined time period (fifteen seconds, for example) has elapsed or not. Here, if it is determined that the predetermined time period has not elapsed (S21: NO), nothing is performed and the step proceeds to S23. However, if the predetermined time period has elapsed (S21: YES), a demonstration effect is provided by the upper liquid crystal display 3 or lower liquid crystal display 4 in S22, and then the step proceeds to S23. In S23, it is determined whether the operation of the RED PLAY1 LINE button 39, the operation of the PLAY2 LINES button 40, the operation of the PLAY5 LINES button 41, the operation of the PLAY20 LINES button 42, or the operation of the BLACK PLAY25 LINES button 43 is performed. Here, when it is determined that the operation of the RED PLAY1 LINE button 39 or the like is not performed (S23: NO), the step returns to S21 to repeat the above-described processing. On the other hand, if it is determined that the operation of the RED PLAY1 LINE button 39 or the like is performed (S23: YES), it is returned to the main processing program of FIG. 36 even in the middle of providing the demonstration effect, and the step proceeds to the lottery processing of S12.

It should be noted that in the determination processing of S23, determination may be performed by means of not only the signals for the above operations but also other input signal.

Next, the lottery processing program performed in the slot machine 1 is described based on FIG. 38. FIG. 38 is a flowchart of the lottery processing program. The lottery processing is performed in S12 of the main processing program shown in FIG. 36. To this end, first of all, the step proceeds to S31 shown in FIG. 38 to perform symbol determination processing. Here, symbols to be displayed in a stop state on the first pay line L1 in the basic game are determined for the variable display sections 21 through 25. Specifically, as described above, five random number values are sampled by the random number sampling circuit 56 so as to correspond to the variable display sections 21 through 25, and symbols to be displayed in a stop state are determined by means of the code numbers on the basis of the lottery table shown in FIG. 9. Once the symbols to be displayed in a stop state on the active pay line are determined, symbol combination determination processing is performed in S32, and thereafter it is returned to the main processing program shown in FIG. 36 to proceed to the basic game processing of S13. It should be noted that the symbol combination determination processing is, to be concrete, for determining winning combinations and the awards thereof on the basis of the table shown in FIG. 8 by means of the above code numbers in S31, as described above.

Next, the basic game processing program performed in the slot machine 1 is described based on FIG. 39. FIG. 39 is a flowchart of the basic game processing program. The basic game processing is performed in S13 of the main processing program shown in FIG. 36. To this end, first of all, in S41 shown in FIG. 39, each symbol is scrolled on each of the variable display sections 21 through 25 on the basis of the switch signals which are received in S11 of FIG. 36 and output from the 1-LINE switch 62, 2-LINES switch 63, 5-LINES switch 64, 20-LINES switch 65, and 25-LINES switch 66.

Then, in S42, scrolling of the each symbol on each of the variable display sections 21 through 25 is stopped.

In S43, credits and the like equivalent to the awards determined based on the table shown in FIG. 8 are paid out in accordance with the combinations of symbols of the winning combinations which are displayed in a stop state in the variable display sections 21 through 25 in S42. It should be noted that after the processing of S43, it is returned to the main processing program of FIG. 36 to proceed to the determination processing of S14.

Next, the bonus game processing program performed in the slot machine 1 is described based on FIG. 40. FIG. 40 is a flowchart of the bonus game processing program. When it is determined that the bonus game is won in S14 of the main processing program of FIG. 36 (S14: YES), the step proceeds to S15 of FIG. 36 to perform the bonus game processing. To this end, first of all, the step proceeds to S51 of FIG. 40 to perform the lottery processing of the bonus game. Here, in the bonus game, the symbols which are displayed in a stop state on the stop display regions 211 through 213, 221 through 223, 231 through 233, 241 through 243, and 251 through 253 are determined for the stop display regions 211 through 213, 221 through 223, 231 through 233, 241 through 243, and 251 through 253 respectively. Specifically, as described above, fifteen random number values are sampled by the random number sampling circuit 56 so as to correspond to the stop display regions 211 through 213, 221 through 223, 231 through 233, 241 through 243, and 251 through 253, and symbols to be displayed in a stop state are determined by means of the code numbers on the basis of the lottery table shown in FIG. 43. Once the symbols to be displayed in a stop state in the stop display regions 211 through 213, 221 through 223, 231 through 233, 241 through 243, and 251 through 253 are determined, a winning combination and its award are determined on the basis of the table shown in FIG. 8 by means of the code numbers of these symbols.

Then in rotation processing of S52, scrolling of each symbol in each of the stop display regions 211 through 213, 221 through 223, 231 through 233, 241 through 243, and 251 through 253 is automatically performed.

In stop control processing of S53, scrolling of the each symbol on each of the stop display regions 211 through 213, 221 through 223, 231 through 233, 241 through 243, and 251 through 253 is stopped.

In payout processing of S54, credits and the like equivalent to the awards determined based on the table shown in FIG. 8 are paid out in accordance with the combinations of symbols of the winning combinations which are displayed in a stop state in the stop display regions 211 through 213, 221 through 223, 231 through 233, 241 through 243, and 251 through 253 in S53.

Next, the step proceeds to S55 to determine whether the number of times that the bonus game is executed reaches the number of times determined in S12 of FIG. 36. At this moment, if it is determined that the number of times that the bonus game is executed does not reach the number of times determined in S12 of FIG. 36 (S55: NO), the step returns to S51 to repeat the abovementioned processing. If, on the other hand, it is determined that the number of times determined in S12 of FIG. 36 is reached (S55: YES), the bonus game processing program is ended.

It should be noted that if the credits are eventually acquired in the bonus game, the bonus game is ended, and thereafter the double down game is played in which the acquired credits are bet, but the explanation thereof is omitted here.

As described above, the CPU 50 functions as “game control means” when executing the main processing program shown in FIG. 36.

As described in detail above, in the slot machine 1 of the present embodiment, the symbol columns shown in the first reel strip 101, the second reel strip 102, the third reel strip 103, the fourth reel strip 104 and the fifth reel strip 105 shown in FIG. 6 are present in the symbol columns which are variably displayed while scrolling respectively in the variable display sections 21 through 25 of the lower liquid crystal display 4 when the basic game is played. Also, the symbol column shown in the bonus game reel strip 111 shown in FIG. 42 is present in the symbol columns which are variably displayed while scrolling in each of the stop display regions 211 through 213, 221 through 223, 231 through 233, 241 through 243, and 251 through 253 when the bonus game is played.

Here, for explanatory convenience, a virtual rotating body, an external surface of which is formed with the symbol column shown in the first reel strip 101 of FIG. 6, is a first virtual reel 101R, a virtual rotating body, an external surface of which is formed with the symbol column shown in the second reel strip 102 of FIG. 6, is a second virtual reel 102R, a virtual rotating body, an external surface of which is formed with the symbol column shown in the third reel strip 103 of FIG. 6, is a third virtual reel 103R, a virtual rotating body, an external surface of which is formed with the symbol column shown in the fourth reel strip 104 of FIG. 6, is a fourth virtual reel 104R, and a virtual rotating body, an external surface of which is formed with the symbol column shown in the fifth reel strip 105 of FIG. 6, is a fifth virtual reel 105R.

Moreover, a virtual rotating body, an external surface of which is formed with the symbol column shown in the bonus game reel strip 111 of FIG. 42, is a bonus game virtual reel 111R.

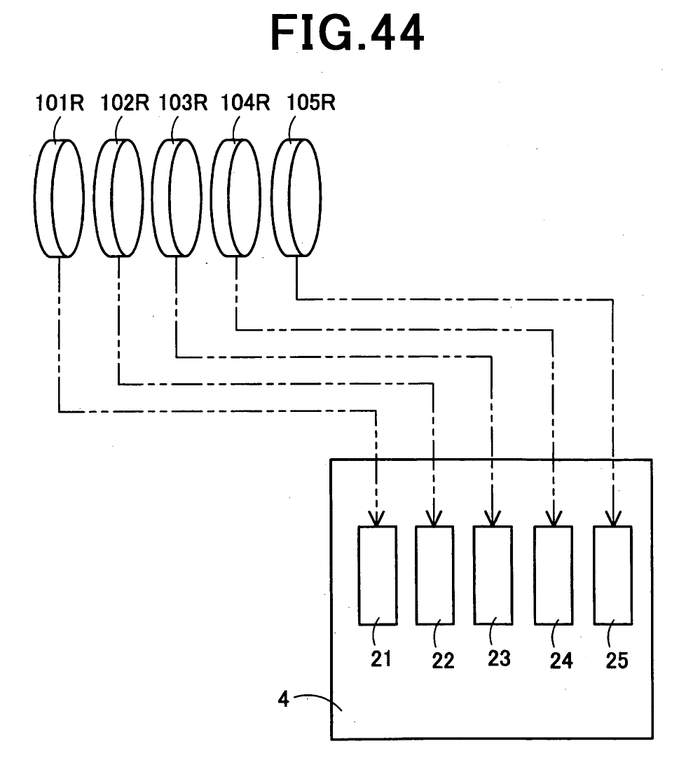

Accordingly, in the slot machine 1 of the present embodiment, when the basic game is played, the first virtual reel 101R is varied/stopped in the variable display section 21 of the lower liquid crystal display 4, the second virtual reel 102R is varied/stopped in the variable display section 22 of the lower liquid crystal display 4, the third virtual reel 103R is varied/stopped in the variable display section 23 of the lower liquid crystal display 4, the fourth virtual reel 104R is varied/stopped in the variable display section 24 of the lower liquid crystal display 4, and the fifth virtual reel 105R is varied/stopped in the variable display section 25 of the lower liquid crystal display 4, but the bonus game virtual reel 111R is not used, as shown in FIG. 44.

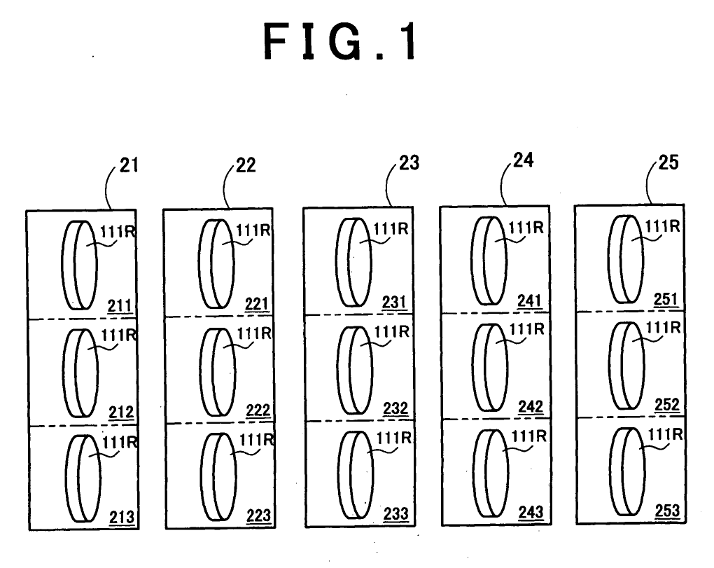

On the other hand, when the bonus game is played, the bonus game virtual reel 111R is varied/stopped in each of the stop display regions 211 through 213, 221 through 223, 231 through 233, 241 through 243, and 251 through 253, but the virtual reels 101R through 105R are not used, as shown in FIG. 1.

Therefore, in the basic game, the first virtual reel 101R, the second virtual reel 102R, the third virtual reel 103R, the fourth virtual reel 104R, and the fifth virtual reel 105R are varied/stopped in the variable display sections 21 through 25 respectively, as shown in FIG. 44.

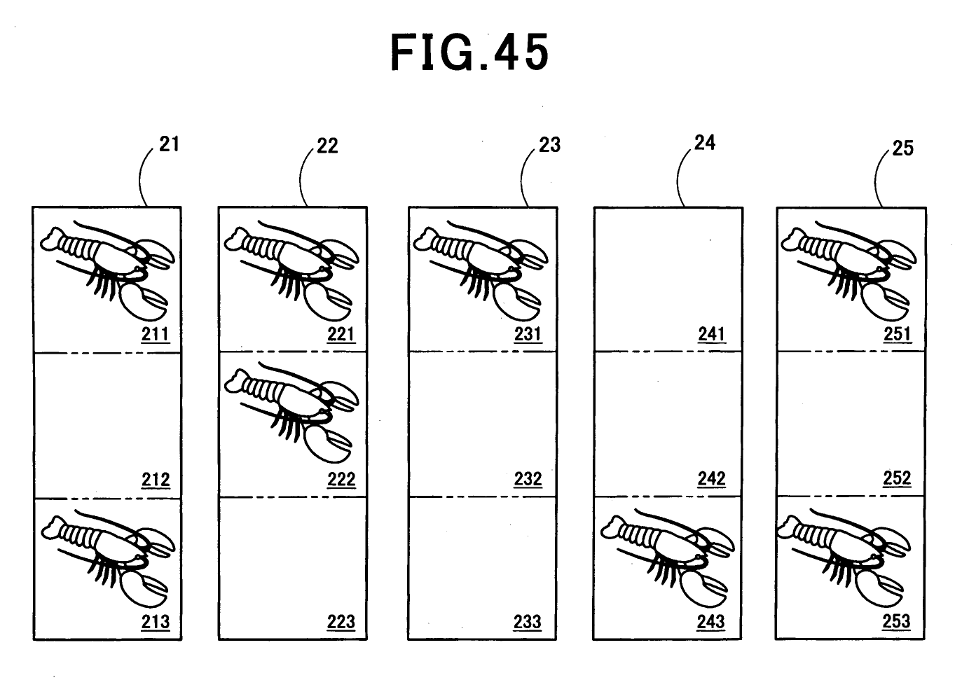

On the other hand, as shown in FIG. 1, in the bonus game, only the bonus game virtual reel 111R is varied/stopped in each of the stop display regions 211 through 213, 221 through 223, 231 through 233, 241 through 243, and 251 through 253. Since only the two symbols, the blank symbol and the symbol of “LOBSTER” (the lobster shown in FIG. 7), are formed in the bonus game virtual reel 111R, for example a combination of the blank symbol and the symbol of “LOBSTER” (the lobster shown in FIG. 7) is displayed in a stop state in each of the stop display regions 211 through 213, 221 through 223, 231 through 233, 241 through 243, and 251 through 253, as shown in FIG. 45.

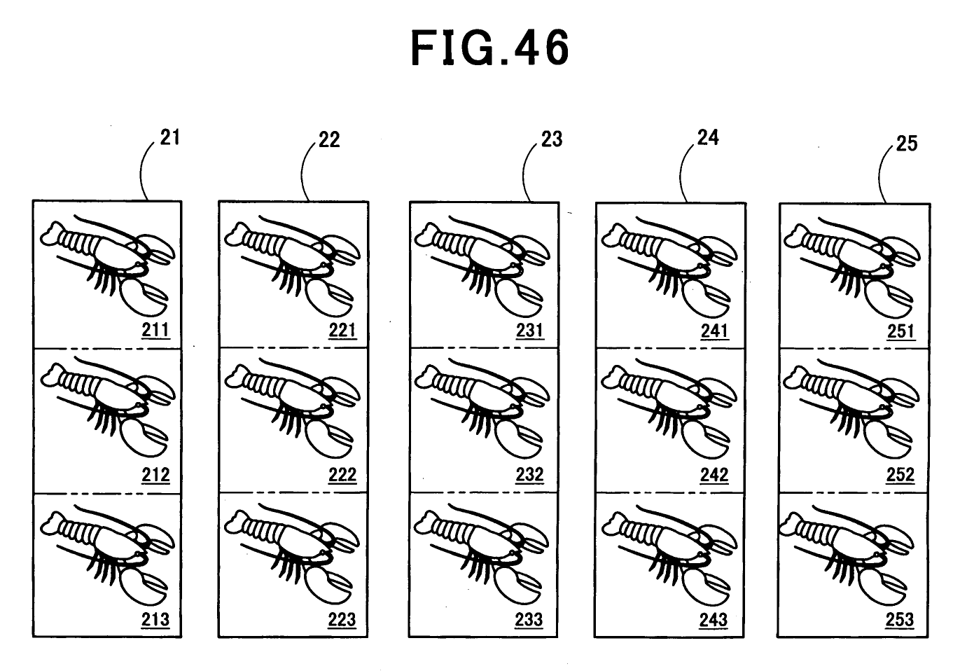

Therefore, for example, a case is conceivable in which the symbol of “LOBSTER” (the lobster shown in FIG. 7) is displayed in a stop state in all of the stop display regions 211 through 213, 221 through 223, 231 through 233, 241 through 243, and 251 through 253, as shown in FIG. 46. In this case, the stop display regions are filled with the symbol of “LOBSTER” (the lobster shown in FIG. 7), thus an extremely strong impact can be provided to the player.

Therefore, in the slot machine 1 of the present embodiment, the video slot game constituted from the basic game and bonus game is executed on the lower liquid crystal display 4. The first virtual reel 101R, the second virtual reel 102R, the third virtual reel 103R, the fourth virtual reel 104R, and the fifth virtual reel 105R shown in FIG. 6 are used in the variable display sections 21 through 25 respectively in the basic game, while the bonus game virtual reel 111R is used in each of the stop display regions 211 through 213, 221 through 223, 231 through 233, 241 through 243, and 251 through 253 in the bonus game. Thus, the number of combinations of symbols on the first virtual reel 101R, the second virtual reel 102R, the third virtual reel 103R, the fourth virtual reel 104R, and the fifth virtual reel 105R shown in FIG. 6, which are displayed in a stop state in the variable display sections 21 through 25 respectively during the basic game, and the number of combinations of symbols on the bonus game virtual reel 111R, which are displayed in a stop state in the stop display regions 211 through 213, 221 through 223, 231 through 233, 241 through 243, and 251 through 253 during the bonus game, reach a high volume, whereby variations of the combinations of the symbols increase and a wide variety of changes in the characteristics of a bonus game in a video slot game can be brought about.

Moreover, in terms of the fact a single virtual reel rotates independently, the stop display regions 211 through 213, 221 through 223, 231 through 233, 241 through 243, and 251 through 253 during the bonus game are equivalent to the variable display sections 21 through 25 during the basic game. Further, the symbols on the bonus game virtual reel 111R used in the bonus game are the two symbols, blank symbol and the symbol of “LOBSTER” (the lobster shown in FIG. 7), while the symbols on the virtual reels 101R through 105R used in the basic game are twelve symbols, “SHARK”, “FISH”, “PUNK”, “OCTOPUS”, “CRAB”, “WORM”, “SARDINE”, “A”, “K”, “Q”, and “J” in addition to the symbol of “LOBSTER (the lobster shown in FIG. 7). Therefore, since the number of symbols on the bonus game virtual reel 111R used in the bonus game is less than the number of symbols on the virtual reels 101R through 105R used in the basic game, there is a clear difference between the combinations of the symbols on the virtual reels 101R through 105R, which are displayed in a stop state in the variable display sections 21 through 25 respectively during the basic game, and the combinations of symbols on the bonus game virtual reels 111R, which are displayed in a stop state in the stop display regions 211 through 213, 221 through 223, 231 through 233, 241 through 243, and 251 through 253 respectively during the bonus game. Consequently, a distinction and an impact can be provided between the basic game and the bonus game.

It should be noted that the present invention is not limited to the above-described embodiment, and thus can be modified variously without departing from the spirit of the present invention.

For example, in the slot machine 1 of the present embodiment, the bonus game virtual reels 111R are varied/stopped on all of the stop display regions 211 through 213, 221 through 223, 231 through 233, 241 through 243, and 251 through 253 as shown in FIG. 1 when the bonus game is played, but the bonus game virtual reels 111R may be varied/stopped in some of the stop display regions 211 through 213, 221 through 223, 231 through 233, 241 through 243, and 251 through 253.

Further, in the slot machine 1 of the present embodiment, although only the two symbols, the blank symbol and the symbol of “LOBSTER” (the lobster shown in FIG. 7), are formed on the bonus game virtual reel 111R, limitation is not made to this example. Thus, as long as the number of symbols to be formed on the bonus game virtual reels 111R is less than the number of symbols formed on the virtual reels 101R through 105R, two or more symbols such as “SHARK”, “FISH”, “PUNK”, “OCTOPUS”, “CRAB”, “WORM”, “SARDINE”, “A”, “K”, “Q”, “J”, and the like may be formed.

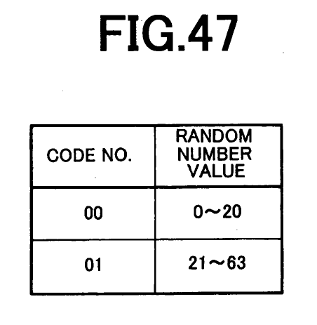

Moreover, in the slot machine 1 of the present embodiment, symbols to be displayed in a stop state in the stop display regions 211 through 213, 221 through 223, 231 through 233, 241 through 243, and 251 through 253 respectively are determined for the stop display regions 211 through 213, 221 through 223, 231 through 233, 241 through 243, and 251 through 253 in accordance with the lottery table shown in FIG. 43 in which one random number value sampled via the random number sampling circuit 56 corresponds to one code No. In this regard, for example, symbols to be displayed in a stop state on the stop display regions 211 through 213, 221 through 223, 231 through 233, 241 through 243, and 251 through 253 respectively may be determined for the stop display regions 211 through 213, 221 through 223, 231 through 233, 241 through 243, and 251 through 253 respectively, on the basis of the lottery table shown in FIG. 47 in which a specific range of random number values sampled via the random number sampling circuit 56 corresponds to one code No.

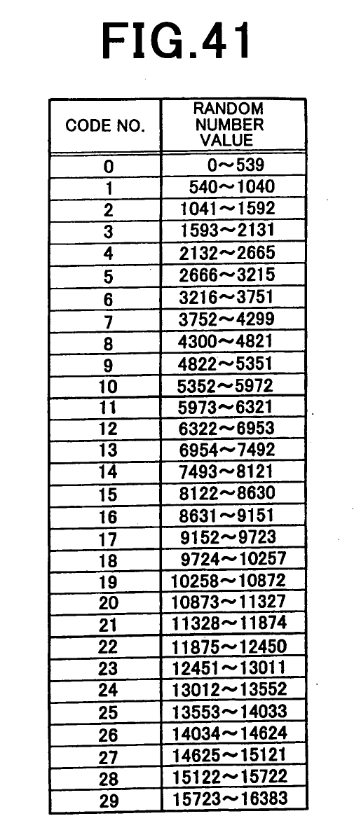

In addition, in the slot machine 1 of the present embodiment, in the basic game and the bonus game symbols to be displayed in a stop state on the first pay line L1 are determined for the variable display sections 21 through 25 respectively, on the basis of the lottery table shown in FIG. 9 in which one random number value sampled via the random number sampling circuit 56 corresponds to one code No. In this regard, for example, symbols to be displayed in a stop state on the first pay line L1 may be determined for the variable display sections 21 through 25 respectively on the basis of the lottery table shown in FIG. 41 in which a specific range of random number values sampled via the random number sampling circuit 56 corresponds to one code No.

What is claimed is:

1. A gaming machine, comprising:
a plurality of basic reel strips which are utilized in a basic game only and on which a plurality of symbols are disposed respectively;
a plurality of variable display sections which perform variable/stop display of the symbols on the respective basic reel strips;
a plurality of stop display regions which are respectively demarcated in the variable display sections and on which one of the symbols on the basic reel strips is displayed in a stop state;
game control unit for utilizing the symbols displayed respectively on the variable display sections in a variable/stop state, to execute a video slot game which is constituted from the basic game and a bonus game; and
a special reel strip which is utilized only in the bonus game and is formed with symbols the number of which is less than the number of symbols on the basic reel strips,
wherein the game control unit executes the bonus game by displaying the symbols, which are formed on the special reel strip, in a variable/stop state in the stop display regions respectively.

2. The gaming machine according to claim 1, wherein the game control unit performs control so as to make a shift to the bonus game when a predetermined symbol is displayed in a stop state by a predetermined number or more in the variable display section, regardless of active pay lines.

3. The gaming machine according to claim 1, wherein the game control unit performs lottery processing of the bonus game when determination is made that the bonus game is won, and determines a symbol to be displayed in a stop state on each of the stop display regions, for each of the stop display regions by means of sampling processing performed by a random number sampling circuit.

4. The gaming machine according to claim 1, wherein the symbol formed on the special reel strip comprises one type of the symbols formed on the basic reel strips and a blank symbol.

5. The gaming machine according to claim 1, wherein the variable display section comprises a liquid crystal display, each of the stop display regions comprises a part of the liquid crystal display region of the variable display section, and each of the basic reel strips and each of the special reel strips comprise a virtual reel demarcated on the liquid crystal display.

6. A gaming machine, comprising:
a plurality of reels;
a plurality of basic reel strips which are utilized in a basic game only and are corresponding to the plurality of reels respectively, and on which a plurality of symbols are disposed respectively;
a special reel strip which is utilized only in the bonus game and is corresponding to the plurality of reels respectively, and is formed with a plurality of symbols the number of which is less than the number of symbols on the basic reel strips; and
a processor programmed to operate with the plurality of reels, the plurality of basic reel strips and one type special reel strip to enable a player to initiate the basic game by making a bet, to play the basic game by utilizing the plurality of basic reel strips on the plurality of reels, to make a shift to the bonus game when a predetermined condition is satisfied in the basic game, and to play the bonus game by utilizing the one type special reel strip on the plurality of reels.

7. A gaming machine, comprising:
a plurality of reels;
a plurality of basic reel strips which are utilized in a basic game only and are corresponding to the plurality of reels respectively, and on which a plurality of symbols are disposed respectively;
a special reel strip which is utilized only in the bonus game and is corresponding to the plurality of reels respectively, and is formed with a plurality of symbols comprising at least one type of winning symbol and blank symbol; and
a processor programmed to operate with the plurality of reels, the plurality of basic reel strips and one type special reel strip to enable a player to initiate the basic game by making a bet, to play the basic game by utilizing the plurality of basic reel strips on the plurality of reels, to make a shift to the bonus game when a predetermined condition is satisfied in the basic game, and to play the bonus game by utilizing the one type special reel strip on the plurality of reels.
